(19) United States
(12) Patent Application Publication
(10) Pub. No.: US 2026/0289080 A1
(43) Pub. Date: Sep. 24, 2026

(54) SYSTEM

(71) Applicant: SoftBank Group Corp., Tokyo (JP)

(72) Inventor: Shoya KUSUNOSE, Tokyo (JP)

(73) Assignee: SoftBank Group Corp., Tokyo (JP)

(21) Appl. No.: 19/562,869

(22) Filed: Mar. 11, 2026

(30) Foreign Application Priority Data
Mar. 19, 2025 (JP) 2025-044553

(51) Int. Cl. G06F 40/166; G06F 40/117; G06F 40/221; G06F 40/253; G06F 40/284; G06F 40/295; G06F 40/40; G06N 3/0475

(52) U.S. Cl. CPC G06F 40/166; G06F 40/117; G06F 40/221; G06F 40/253; G06F 40/284; G06F 40/295; G06F 40/40; G06N 3/0475

(57) ABSTRACT

A system includes a processor that is configured to acquire information from an information source by using a data collection means for acquiring information, analyze the acquired information by using a natural language processing technique, edit the information based on a result of the analysis, generate a prompt sentence by using a generative AI model based on the edited information, and generate an article by inputting the prompt sentence to the generative AI model.

### CROSS-REFERENCE TO RELATED APPLICATION

This application is based on and claims priority under 35 USC 119 from Japanese Patent Application No. 2025-044553 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional techniques for generating articles from various information sources, such as web pages, bulletin boards, documents, and databases, require substantial manual intervention at multiple stages, including collection of source information, analysis and understanding of the content, editing and structuring of the information, and drafting of text to be used as input for generative models or for manual writing. As the volume and variety of available information continue to increase, it becomes increasingly difficult and time-consuming for users or system operators to perform these processes efficiently and consistently, particularly when natural language processing is needed to identify important points, logical relationships, or narrative flow. Furthermore, there is a need for a system that can flexibly utilize both conventional natural language processing techniques and generative AI models, not only to analyze information but also to prepare suitable prompts and generate final articles in a coherent and contextually appropriate manner. However, existing systems often treat generative AI merely as a final text generator and do not effectively integrate it into the analysis and prompt-generation stages, leading to suboptimal quality, lack of automation, and insufficient adaptability to various content sources and output requirements. Accordingly, there is a demand for a system that can automatically acquire information from information sources, analyze and edit the information using natural language processing, generate appropriate prompt sentences by using a generative AI model, and generate high-quality articles by inputting the prompt sentences into the generative AI model, thereby reducing manual workload and improving the efficiency and consistency of article generation.

### SUMMARY

In order to solve the above-described problems, the present invention provides a system comprising a processor, wherein the processor is configured to acquire information from an information source by using a data collection means for acquiring information, analyze the acquired information by using a natural language processing technique, edit the information based on a result of the analysis, generate a prompt sentence by using a generative AI model based on the edited information, and generate an article by inputting the prompt sentence to the generative AI model. According to one aspect, the processor is further configured to analyze the information by using the generative AI model and to generate the prompt sentence, thereby allowing the generative AI model itself to participate in the interpretation, classification, summarization, or extraction of key elements from the acquired information, and to produce a prompt sentence that is optimized for subsequent article generation. According to another aspect, the processor is configured to automatically generate the article by using the prompt sentence and to provide the generated article to a user, for example through a network-connected terminal or user interface, such that the user can directly obtain a completed article without manually performing intermediate analysis or editing steps. By integrating the data collection means, natural language processing, generative AI-based prompt generation, and generative AI-based article generation into a unified processing flow executed by the processor, the system of the present invention enables highly automated, consistent, and efficient generation of articles from diverse information sources.

The term “system” refers to a combination of hardware and software components, including at least one processor and associated memory and interfaces, that cooperatively execute the functions described in the claims.

The term “processor” refers to one or more central processing units (CPUs), graphics processing units (GPUs), microprocessors, or other information processing circuitry capable of executing instructions to perform the operations described in the claims.

The term “information source” refers to any source from which information can be obtained, including but not limited to web sites, databases, file systems, application programming interfaces (APIs), local or remote storage devices, and network-connected services.

The term “data collection means” refers to hardware, software, or a combination thereof that is configured to acquire information from an information source, for example by sending requests over a network, reading from storage, or invoking external services or APIs.

The term “natural language processing technique” refers to any algorithm, model, or method for analyzing or processing text expressed in a natural language, including but not limited to tokenization, parsing, part-of-speech tagging, named entity recognition, sentiment analysis, summarization, topic classification, or semantic analysis.

The term “analyze the acquired information” refers to applying one or more natural language processing techniques or generative AI functions to the information obtained from the information source in order to extract features, determine meanings, identify structures, or otherwise derive analysis results used in subsequent processing.

The term “edit the information” refers to modifying, selecting, structuring, rearranging, summarizing, or otherwise transforming the acquired information based on an analysis result so as to produce edited information suitable for subsequent prompt generation and article generation.

The term “generative AI model” refers to a machine learning model, such as a large language model or other neural network-based generative model, that is capable of generating natural language text in response to input data including prompts.

The term “prompt sentence” refers to a piece of text, which may comprise one or more sentences, that is generated based on edited information and is used as input to the generative AI model to control or guide the content, style, or structure of an article to be generated.

The term “article” refers to a structured body of natural language text generated by the generative AI model based on a prompt sentence, and intended to be read by a user, such as a news article, summary article, report, or descriptive narrative.

The term “generate a prompt sentence” refers to causing the generative AI model or related logic to produce a text prompt from the edited information so that the produced prompt can be used as input to a generative AI model for article generation.

The term “generate an article” refers to causing the generative AI model to output a body of text in response to an input prompt sentence, where the output text forms the article.

The term “analyze the information by using the generative AI model” refers to utilizing the generative AI model, optionally in conjunction with prompts or instructions, to perform interpretation, classification, summarization, extraction, or other analytical operations on the acquired information.

The term “automatically generate the article” refers to generating the article by the processor and the generative AI model without requiring manual drafting of the article text by a user during the generation process.

The term “provide the generated article to a user” refers to making the article accessible to the user, for example by transmitting the article to a terminal, displaying it on a screen, storing it in a location accessible to the user, or delivering it via a network-based service.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

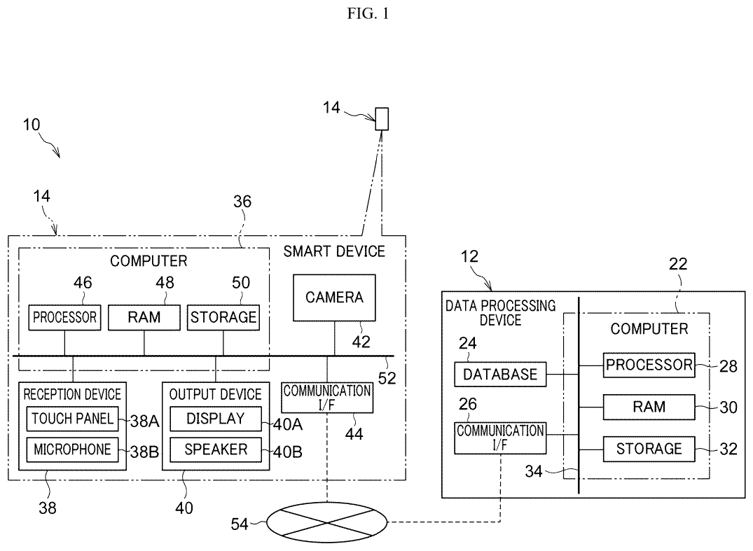

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

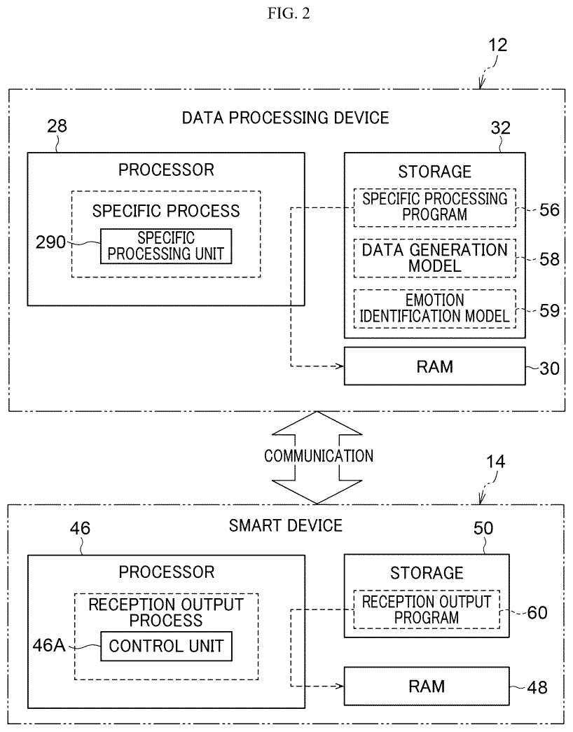

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional techniques for generating summary articles from network-based discussion content, such as online forums or anonymous bulletin boards, typically rely on either manual curation by human operators or on simple keyword extraction and rule-based summarization. Such approaches suffer from several technical problems when implemented in computer systems.

First, a conventional server generally processes large volumes of unstructured text in a linear or thread-order manner without computing fine-grained importance indices, topic classifications, or humor-related features for individual posts. As a result, the server cannot efficiently prioritize posts or segments that are actually salient to the user's intent, which leads to excessive data transfer, increased memory usage, and increased processing time on both the server side and the client side. This causes the overall computing system to waste computational resources on irrelevant or low-importance content.

Second, in many existing systems, a generative AI model is used only in a monolithic way, for example by directly inputting the entire thread text as a prompt and requesting a summary. In such a configuration, the server does not exploit structured pre-analysis, importance scoring, or selective formatting, and therefore cannot effectively control which textual segments are emphasized or how they are organized in the generated article. This lack of structure leads to prompts that are overly long or noisy, increasing the computational load on the generative AI model and degrading the determinism and reproducibility of the generated output.

Third, conventional article generation pipelines generally do not maintain a strong linkage between the original thread structure and the final output structure. The server often fails to preserve a machine-readable mapping between each generated section and the corresponding source posts and metadata. Consequently, the system cannot programmatically determine chapter boundaries, quotation placement, or emphasis formatting in a reproducible way. This limits the ability of the server to automatically produce high-quality output documents in standardized markup or electronic document formats, and forces additional manual post-processing.

Fourth, existing systems typically treat emphasis formatting and visual highlighting as a presentation-layer concern that is applied after natural language processing. Because the system does not compute and store emphasis-related mark information as part of the internal edited information, the server cannot exploit this information to influence the behavior of the generative AI model or to consistently reflect the same emphasis in multiple output formats (for example, both HTML and electronic documents). This results in inconsistencies between internal analysis results and the final article appearance, and also causes redundant processing steps.

Accordingly, there is a need for a computer-implemented system and server-side processing architecture that: (i) automatically parses document-structured discussion content into post-level units with associated metadata, (ii) computes, for each post, an importance index, emotion information, and topic classification information using natural language processing, (iii) constructs edited information that embeds emphasis-related mark information at the text-segment level, (iv) generates prompt sentences for a generative AI model based on such structured analysis and edited information, and (v) automatically generates article data with chapter structure and quotation placement determined from the computed indices and grouping results, while converting the article data into standardized markup or electronic document formats accessible from a user terminal. Such a system improves the efficiency, controllability, and reproducibility of computer-based article generation from large-scale, unstructured discussion content, thereby improving the operation of computer technology itself rather than merely automating a human editorial task.

The specific processing by the specific processing unit 290 of the data processing device 12 in Example 1 is realized by the following means.

The present invention provides a server comprising a processor configured to acquire, from a posting source on a communication network, information having a document structure; to analyze the document structure included in the acquired information to extract text data in units of posts together with associated metadata; to perform, on the extracted text data, natural language processing using a statistical language model or a machine learning model to calculate, for each post, an importance index, emotion information, and topic classification information; to edit the extracted text data based on the calculated importance index and the topic classification information by selecting posts, performing reordering and grouping, and associating text portions determined to be important with mark information for emphasis so as to generate structured edited information; to generate a prompt sentence for a generative AI model based on the edited information and analysis information including a result of the natural language processing; to generate article data by inputting the prompt sentence to the generative AI model so as to obtain a summary article or an explanatory article in which the mark information for emphasis in the edited information is reflected; and to convert the article data into a standardized markup format or an electronic document format and provide the converted article data in a form accessible from a user terminal. This enables the server to improve computer-based processing of large-scale, unstructured discussion data by structurally pre-analyzing and editing post-level content, by supplying the generative AI model with compact and semantically rich prompt sentences, and by automatically producing machine-readable article outputs whose chapter structure, quotation placement, and emphasis formatting are programmatically determined from computed importance indices and grouping results, thereby enhancing computational efficiency, output quality, and reproducibility of article generation within the computer system.

The term “processor” refers to a hardware or virtual processing unit, such as a central processing unit or a graphics processing unit, or a combination thereof, configured to execute instructions of a computer program to perform the functions described in the present disclosure.

The term “information source” refers to any server, storage device, or network-accessible system that provides information having a document structure, including but not limited to discussion services, bulletin-board services, or forum services accessible via a communication network.

The term “communication network” refers to any wired or wireless data communication infrastructure, including local area networks, wide area networks, and public networks such as the Internet, through which the server can transmit and receive data.

The term “document structure” refers to a structural representation of information including elements such as titles, paragraphs, posts, replies, identifiers, timestamps, and metadata, as defined by a markup language, a data format, or a layout convention.

The term “posting source” refers to a system or service that stores and provides user-submitted content in a structured or semi-structured form, such as threads or posts arranged according to a document structure.

The term “information acquisition unit” refers to a functional component implemented by the processor executing instructions to send requests to an information source, receive responses, and obtain information having a document structure.

The term “structure analysis unit” refers to a functional component implemented by the processor executing instructions to parse the document structure of acquired information and to extract text data in units of posts together with associated metadata.

The term “text data” refers to character-based information obtained from the document structure, including the textual content of posts, replies, titles, and other human-readable segments, excluding non-textual binary data.

The term “post” refers to a discrete unit of user-submitted content within the document structure, including at least a body of text and optionally metadata such as an identifier, an author indication, and a timestamp.

The term “metadata” refers to information associated with text data or posts that describes attributes of the content, including but not limited to identifiers, timestamps, authorship information, and thread relationships.

The term “natural language processing” refers to a class of computational techniques that analyze, interpret, and transform human language text using statistical language models, machine learning models, or rule-based models.

The term “statistical language model” refers to a computational model that assigns probabilities to sequences of words or tokens based on statistical patterns learned from text data.

The term “machine learning model” refers to a computational model trained on data to perform tasks such as classification, regression, clustering, or sequence modeling, including but not limited to neural network models and transformer-based models.

The term “importance index” refers to a numerical or categorical indicator computed for each post that represents a relative degree of significance or relevance of that post within the set of posts.

The term “emotion information” refers to information indicating one or more emotional characteristics of a post or text segment, such as positivity, negativity, neutrality, or specific affective states, as determined by natural language processing.

The term “topic classification information” refers to information indicating a topic or category assigned to a post or text segment, as determined by a classification or clustering process performed in natural language processing.

The term “editing unit” refers to a functional component implemented by the processor executing instructions to select, reorder, group, and modify text data and associated metadata based on analysis results such as importance indices and topic classifications.

The term “edited information” refers to a structured representation of text data and metadata after processing by the editing unit, including selections of posts, reordering results, grouping results, and associated emphasis information.

The term “grouping” refers to a process of arranging posts or text segments into sets or sections based on criteria such as topic classification, reply relationships, or importance indices.

The term “mark information for emphasis” refers to information that specifies one or more portions of text to be visually or semantically emphasized in an output document, including but not limited to tags, flags, or codes indicating bolding, highlighting, or other emphasis styles.

The term “prompt generation unit” refers to a functional component implemented by the processor executing instructions to construct a prompt sentence or message for input to a generative AI model based on edited information and analysis information.

The term “prompt sentence” refers to a text input provided to a generative AI model, including instructions, context, and content excerpts, that guides the behavior and output of the generative AI model.

The term “generative AI model” refers to a machine learning model configured to generate text, including but not limited to transformer-based language models that produce natural language output in response to a prompt sentence.

The term “analysis information” refers to information produced by natural language processing, including importance indices, emotion information, topic classification information, extracted key phrases, and any derived summaries or annotations.

The term “article generation unit” refers to a functional component implemented by the processor executing instructions to input a prompt sentence to a generative AI model, to obtain generated text, and to construct article data based on the generated text and edited information.

The term “article data” refers to a machine-readable representation of a summary article, explanatory article, or other textual output produced from the posts, including chapter structure, quotations, and emphasis formatting.

The term “summary article” refers to article data that condenses and reorganizes content from a plurality of posts so as to present key points, storyline, and important information in a shortened form.

The term “explanatory article” refers to article data that explains, interprets, or comments on content from a plurality of posts, including narrative descriptions and contextual information.

The term “chapter structure” refers to a logical organization of article data into sections, chapters, or headings, determined based on analysis results and edited information.

The term “quotation placement” refers to a decision of where and how to insert text segments corresponding to original posts into the article data as quotations or referenced excerpts.

The term “output unit” refers to a functional component implemented by the processor executing instructions to convert article data into an output format and to provide the converted data to an external device or service.

The term “standardized markup format” refers to a document format that uses a markup language with defined tags and structure, such as a hypertext format or an extensible markup format, which is suitable for rendering or further automated processing.

The term “electronic document format” refers to a digital file format for representing documents, including but not limited to portable document formats or other page description formats suitable for viewing or printing.

The term “user terminal” refers to any client device operated by a user, such as a personal computer, a smartphone, a tablet, or another computing device, configured to communicate with the server via a communication network and to present information to the user.

In one embodiment, a server implements the claimed system as a network-accessible article generation platform. The server includes at least one processor, a main memory, a non-volatile storage device, and a network interface. The processor executes a software stack including an operating system, a web application framework, a database management system, and a set of natural language processing components. The terminal is a client device such as a personal computer, a smartphone, or a tablet that communicates with the server via a communication network and presents a user interface. The user operates the terminal to supply an address of a discussion thread and to view a generated article.

The server uses, for example, a general-purpose central processing unit and optionally a graphics processing unit. The server runs an operating system such as a generic server operating system, and runs a web application framework such as a generic web framework for processing HTTP requests. The server stores acquired discussion data and generated article data in a relational database such as a generic relational database, and optionally in an in-memory data store. The server uses a network library to send and receive HTTP requests to and from information sources on the communication network.

The server acquires information having a document structure from a posting source such as an online discussion service or bulletin-board service. The server uses, for example, a generic HTTP client library to send a request to a given thread URL, and the server receives the HTML or other markup representing the thread. When the posting source loads content dynamically with script execution, the server uses a browser automation tool such as a generic headless browser driven by a browser driver to render the page and to obtain the fully rendered document structure. The server stores the acquired document in memory as a text buffer and parses the document structure using a markup parsing library such as a generic markup parser. The server identifies thread-level elements, post containers, and metadata fields (for example, identifiers, timestamps, and author indications) by matching tag names, attributes, and structural patterns defined for the particular posting source.

The server extracts text data in units of posts and associated metadata. The server represents each post as a record in a data structure such as a list or array of dictionaries, each dictionary containing fields including post identifier, author indication, timestamp, and body text. The server maintains the original sequence position for each post and stores a thread identifier for association. This explicit data structure enables the server to process posts independently, to reorder them, and to group them without re-parsing the original document each time, which reduces repeated string processing and improves processing speed.

The server performs natural language processing on the extracted text data using a combination of a statistical language model and a machine learning model. In one embodiment, the server employs a transformer-based neural network model such as a bidirectional encoder model and a generative language model as the generative AI model. The server uses a tokenizer component to convert each post body into a sequence of subword tokens, and the server maps tokens to indices in a vocabulary. The server constructs input tensors representing token sequences, attention masks, and segment identifiers, and the server feeds these tensors to the encoder model executing on the processor or the graphics processing unit.

The server computes, for each post, an importance index, emotion information, and topic classification information. The server uses the final hidden state corresponding to a special classification token of the encoder model as a post-level feature vector. The server applies a classifier head implemented as a fully connected neural layer with a non-linear activation function to this feature vector to obtain a scalar or vector indicating post importance. The server applies an additional classifier head to output a probability distribution over emotion categories. The server applies another classifier head or a clustering algorithm to assign a topic classification label. The server uses a loss function such as cross-entropy loss for each classifier during training, and the server uses backpropagation and a gradient-based optimizer such as a variant of stochastic gradient descent to update model weights during an offline training phase. The server stores the trained weights and uses them in an inference mode during run-time operation.

The server trains the encoder model and the classifier heads using training data that consists of posts and annotations indicating manually judged importance, emotion categories, and topics. The server performs data augmentation, for example by paraphrasing, synonym replacement, or noise injection, to improve the robustness of the model. The server monitors an evaluation metric such as F1 score or area under a receiver operating characteristic curve to verify that the model achieves a desired accuracy. As a result, the server is able to compute importance indices and semantic attributes in a more consistent and scalable manner than a human operator, thereby improving the precision and recall of important content selection.

The server edits the extracted text data based on the calculated importance index and topic classification information. The server selects posts whose importance index exceeds a threshold or whose rank is within a predetermined top percentage. The server performs grouping of posts by topic classification label or by reply relationships derived from the metadata. The server reorders posts within each group according to the original chronological order or according to an importance-based order. The server identifies text portions within each post to be emphasized, for example by computing attention weights at the token level or by using a key phrase extraction algorithm that scores n-grams based on frequency, positional information, and mutual information with the thread title. The server associates the identified text portions with mark information for emphasis, for example by inserting internal tags or by storing character index ranges and associated emphasis types in the data structure. The server generates edited information that comprises, for each post, the body text, the importance index, the topic group, and the emphasis marks for specific character ranges.

The server generates a prompt sentence for the generative AI model based on the edited information and analysis information. The server constructs a textual prompt that includes an instruction part, a context part, and a data part. The server writes the instruction part to specify that the generative AI model should extract a storyline, important posts, funny or entertaining points, and key phrases. The server writes the context part to include the thread title and an overview of the thread derived from the encoder model's aggregated representations. The server writes the data part to list selected posts along with their importance indices and any annotation derived from the natural language processing, such as emotion labels and topic labels. By including compact, pre-analyzed information instead of raw, unstructured thread content, the server reduces the number of tokens that need to be processed by the generative AI model and thereby reduces computation time and memory usage within the generative AI model.

In one example, the server constructs an internal prompt sentence in the following manner:

“You are a generative AI model analyzing a thread from an anonymous bulletin board. Below are the thread title and selected posts with importance scores and topic labels.
1. Describe the overall flow of the conversation.
2. Identify the most important posts (use post IDs).
3. Extract funny or entertaining points and explain why they are funny.
4. Provide 5-10 key phrases that represent the thread.
Thread title: [TITLE]
Posts:
[POST_ID=1, importance=0.92, topic=‘episode’] [TEXT . . . ]
[POST_ID=5, importance=0.88, topic=‘reaction’] [TEXT . . . ]
. . . ”

In another example, the server constructs a prompt sentence focused on article generation:

“You are an editor creating a summary article from an anonymous bulletin board thread.

Use the analysis results below (important posts, funny points, key phrases) and write a coherent article for general readers.

### Requirements

Preserve the original humorous tone.
Explain the overall flow of the conversation in an easy-to-understand manner.
Include direct quotes from key posts, but keep them concise.

### Analysis Results

[ANALYSIS_TEXT_HERE]”

In a further example, the server constructs a prompt sentence starting from a network resource:

“From the thread obtained from the following URL, extract the flow of the conversation and the funny points, and generate a readable summary article in English.
URL: [BULLETIN_BOARD_URL]”

The server inputs such prompt sentences to the generative AI model via an application programming interface. The server uses, for example, a transformer-based decoder or encoder-decoder architecture as the generative AI model, with multiple attention layers, feedforward layers, and residual connections. The server stores parameters of the generative AI model that have been trained on large-scale text corpora using unsupervised or semi-supervised learning methods, such as next-token prediction or masked language modeling. The server optionally fine-tunes the generative AI model on domain-specific data consisting of discussion threads and manually created summaries.

The server receives generated text from the generative AI model, such as a narrative description of the thread, a list of important posts, explanations of funny points, and a set of key phrases. The server parses the generated text based on structural cues (for example, headings, numbered lists, or delimiters) that the server has specified in the prompt. The server maps references to post identifiers in the generated text back to the corresponding posts in the edited information. By using explicit identifiers and structured prompts, the server ensures that the output of the generative AI model is tightly coupled with the underlying data structures, enabling automatic post-to-article mapping and reducing ambiguity.

The server generates article data by combining the generated text from the generative AI model with the edited information that includes emphasis marks and grouping results. The server determines a chapter structure based on topic groups, such as an introduction section, main storyline section, episode sections, and reaction sections. The server determines quotation placement by selecting post excerpts that the generative AI model or the importance index has indicated as significant and inserting them at positions indicated by the article outline. The server applies the emphasis marks to the text segments of quotations, such as using bold-like emphasis or highlight-like emphasis. The server represents the article data as a structured object with fields representing chapters, paragraphs, quotations, emphasis spans, and metadata such as the original thread URL.

The server converts the article data into a standardized markup format such as a generic hypertext format. The server uses a template engine to embed the article data into predefined templates that define document structure and presentation. The server generates markup that includes tags for headings, paragraphs, quotation blocks, and emphasis spans. The server also converts the article data into an electronic document format such as a generic page description format using a conversion tool that interprets the markup and applies layout rules. The server provides the resulting document via a network interface, such that the terminal can retrieve the document and display it to the user using a browser or a document viewer.

The terminal receives a uniform resource locator or direct content from the server and renders the markup or electronic document format for presentation. The user operates the terminal to scroll through the article, to follow internal links between sections, or to trigger download of a document file. The terminal may cache the retrieved document to reduce repeated network traffic and improve responsiveness.

This configuration improves computer technology in several respects. The server uses a specific data structure for representing posts and analysis results, enabling selective processing and caching, which reduces the need to repeatedly parse large raw documents. The server performs structured natural language processing at the post level to compute importance indices, emotion information, and topic classification information. Because the server uses trained neural network models with classifier heads for these tasks, the server can more accurately distinguish important posts from noise, thereby reducing the volume of data that needs to be passed to the generative AI model.

The server reduces computational load on the generative AI model by generating compact, semantically rich prompt sentences based on pre-analysis. The server includes only selected posts and distilled features (importance indices, topic labels, and key phrases) rather than full thread content. As a result, the number of tokens processed by the generative AI model decreases, which in turn reduces inference time and memory consumption. This reduction is significant for long threads, and the server thus improves overall throughput and latency of the system.

The server improves data management by maintaining traceable mappings between original posts, analysis attributes, and article segments. These mappings allow the server to re-generate article formats, to revise emphasis styles, or to re-group sections without re-running the generative AI model, because the server can reuse existing analysis and edited information. This reduces repeated inference calls, further lowering computational cost and network traffic to external model endpoints.

The server employs non-conventional processing steps that are different from mere human editorial automation. For example, the server uses attention distributions and classifier outputs to assign emphasis marks at a sub-sentence level according to numerical thresholds and learned patterns that are not available to human editors without algorithmic support. The server organizes posts into topic-based groups using clustering or classification algorithms applied to encoder representations, and this grouping determines chapter structure algorithmically rather than through human judgment. The server enforces a rule that only posts above a certain importance index threshold and belonging to certain topic labels are passed to the generative AI model, a rule designed to maximize relevance while minimizing token count, which is specific to the computational constraints of neural language models.

The server further improves accuracy and reduces error by training neural network components with clearly defined loss functions and optimization routines. The server can incorporate techniques such as regularization, batch normalization, and learning rate scheduling to achieve stable training. The server can also perform model calibration or threshold tuning on validation data to align the importance index outputs with desired recall and precision levels. As a result, the server reduces misclassification of post importance and improves the consistency of highlighting and sectioning in the generated article.

In alternative embodiments, the server may use different neural architectures, such as recurrent neural networks, convolutional neural networks, or alternative transformer variants for the encoder and generative AI model. The server may also use unsupervised topic modeling or graph-based ranking methods to complement or replace certain classifier heads. The server may implement additional features, such as calculating a novelty score for each post or a redundancy score to avoid repeating similar content in the article. The server may adjust the prompt composition strategy, for example by including explicit constraints on maximum article length or on the number of quotations to be generated.

In a further embodiment, the server may integrate a feedback mechanism in which the user evaluates generated articles through the terminal, and the server logs these evaluations to adjust thresholds or to retrain classifier components. The server may use reinforcement learning or preference-based learning to adapt the generative AI model's behavior to the user's preferences. Such feedback-driven adaptation further refines the technical performance of the system by reducing undesired outputs over time.

Through these embodiments, the server, the terminal, and the user collectively implement a system in which large-scale, unstructured discussion data is transformed into structured, accessible article data. The described combination of specialized data structures, neural-network-based analysis components, prompt generation rules, and document generation procedures yields technical effects including improved processing speed, reduced computational and communication load, enhanced selection accuracy, and consistent multi-format output generation, thereby providing an improvement to computer-based text processing technology itself.

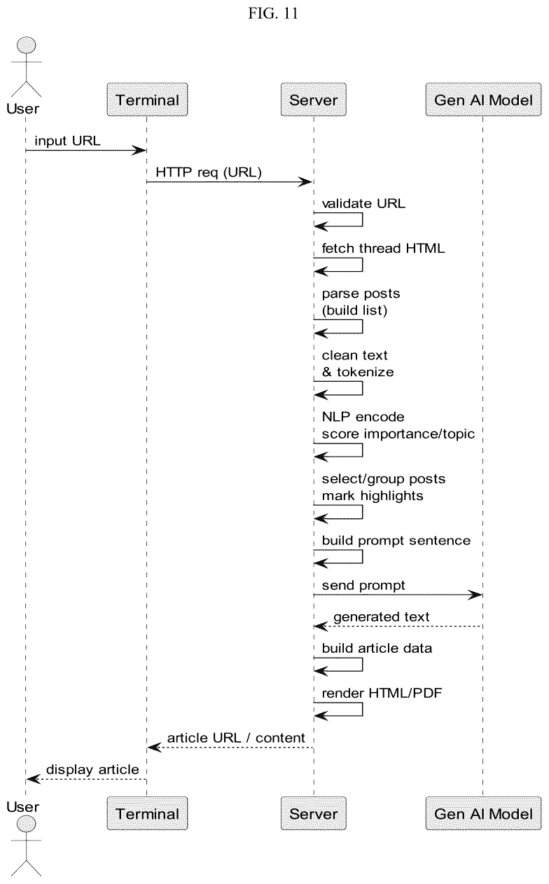

The following describes the processing flow using FIG. 11.

### Step 1

The terminal displays an input screen that includes a text field for a thread URL and a submission control. The user operates the terminal to input a URL of a discussion thread on an anonymous bulletin board and to activate the submission control. The terminal sends an HTTP request including the URL as an input parameter to the server. The input of this step is the URL string entered by the user, and the output is an HTTP request containing the URL that is transmitted from the terminal to the server.

### Step 2

The server receives the HTTP request from the terminal and parses the request to extract the URL parameter. The server validates the URL format and checks whether the domain belongs to an allowed set. The server logs the request and, if valid, stores the URL together with a request identifier in a storage device. The input of this step is the HTTP request containing the URL, and the output is a stored request record that includes the validated URL and the associated request identifier.

### Step 3

The server uses a network communication library to send an HTTP request to the information source indicated by the stored URL. The server receives a response that includes a document structure, typically in a markup format. When the response content is dynamically generated via scripts, the server uses a headless browser tool to execute the scripts and retrieve the rendered document. The input of this step is the validated URL from the stored request record, and the output is a raw document string representing the thread page in a markup language.

### Step 4

The server parses the raw document using a markup parsing library to identify elements corresponding to thread metadata and individual posts. The server extracts, for each post, a post identifier, an author indication if present, a timestamp, and a body text portion. The server constructs a structured representation such as an array of records, each record containing the extracted fields. The input of this step is the raw document string, and the output is a structured post list and associated thread metadata.

### Step 5

The server preprocesses the text data in the structured post list. The server removes markup tags, decodes character entities, normalizes whitespace, and filters out script and style content. The server optionally removes or masks sensitive information such as contact data. The server prepares the cleaned text data as a set of text sequences associated with post identifiers. The input of this step is the structured post list, and the output is a cleaned text dataset in which each entry contains a post identifier and its corresponding cleaned text.

### Step 6

The server tokenizes each cleaned text sequence using a tokenizer associated with an encoder model. The server converts each token to a numerical index based on a predefined vocabulary and constructs input tensors that include token indices, attention masks, and segment identifiers. The server enforces a maximum sequence length by truncating or segmenting long posts. The input of this step is the cleaned text dataset, and the output is a set of numerical tensors and associated post identifiers suitable for input to a neural network model.

### Step 7

The server executes an encoder model, such as a transformer-based neural network, on the numerical tensors. The server feeds the tensors to the model and obtains hidden state vectors for each token and an aggregated vector for each post. The server applies classifier layers to the aggregated vectors to compute numerical values representing an importance index, emotion category probabilities, and topic classification probabilities for each post. The input of this step is the set of numerical tensors and post identifiers, and the output is an analysis result set that assigns, to each post identifier, an importance index, an emotion label, and a topic label.

### Step 8

The server combines the analysis result set with the original post texts to create edited information. The server selects posts whose importance index exceeds a threshold or whose rank is within a predetermined range. The server groups posts by topic label or reply relationship and orders posts within each group according to importance index or timestamp. The server identifies key text spans within each selected post by using token-level attention values or a key phrase scoring algorithm and associates emphasis marks with the character ranges of those spans. The input of this step is the analysis result set and the cleaned text dataset, and the output is structured edited information that includes selected posts, group assignments, ordering, and emphasis marks for text spans.

### Step 9

The server constructs a prompt sentence for a generative AI model by composing instruction text, context text, and data text. The server writes instruction text that describes desired tasks, such as summarizing the thread, identifying key posts, extracting funny points, and listing key phrases. The server writes context text that includes the thread title and a brief description derived from aggregated encoder vectors. The server writes data text that lists selected posts along with their importance indices and topic labels and includes excerpts of their body texts. The server concatenates these parts into a single prompt sentence while ensuring that the total length does not exceed a token limit. The input of this step is the structured edited information and the thread metadata, and the output is a composed prompt sentence tailored for the generative AI model.

### Step 10

The server sends the composed prompt sentence to the generative AI model via an application programming interface. The server specifies model parameters such as maximum output length and decoding strategy. The generative AI model receives the prompt sentence and generates a text output, which is returned to the server through the interface. The server receives the generated text and stores it in association with the request identifier. The input of this step is the prompt sentence, and the output is generated text that includes a narrative summary, identified important posts, explanations of funny points, and key phrases.

### Step 11

The server parses the generated text to identify structural components such as headings, paragraphs, lists, and references to post identifiers. The server associates referenced post identifiers with the corresponding posts in the edited information and determines where quotations should be inserted in the final article. The server constructs article data that includes a chapter structure, narrative paragraphs, quotation segments, and emphasis instructions derived from the emphasis marks in the edited information. The input of this step is the generated text and the structured edited information, and the output is a structured article data object that represents the summary or explanatory article at a logical level.

### Step 12

The server converts the structured article data into a standardized markup format by applying a template engine. The server maps chapter titles to heading elements, narrative text to paragraph elements, quotations to quotation elements, and emphasis marks to emphasis tags. The server generates a complete markup document that includes metadata such as the original thread URL and generation timestamps. The input of this step is the structured article data object, and the output is a markup document string that encodes the article content and structure.

### Step 13

The server optionally converts the markup document into an electronic document format using a document conversion tool. The server passes the markup document to the conversion tool, which renders the layout and produces a document file. The server stores the document file and associates a download path or identifier with the request identifier. The input of this step is the markup document string, and the output is an electronic document file that contains a formatted version of the article.

### Step 14

The server generates a response for the terminal that includes either the markup document or a reference to the markup document and, optionally, to the electronic document file. The server transmits this response to the terminal over the communication network. The terminal receives the response and renders the markup document in a browser or opens the electronic document file in a viewer. The user operates the terminal to read the generated article, to navigate between sections, and to save or print the document. The input of this step is the markup document string and any associated document file identifiers, and the output is a displayed or accessible article on the terminal that presents the summarized discussion to the user.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional content summarization systems that process user-generated text from large-scale online discussion platforms suffer from several technical deficiencies when implemented on general-purpose computer hardware. First, such systems typically treat a discussion thread as a flat sequence of text and do not compute explicit conversation flow information, topic structure, or post-level importance scores in a machine-usable form. As a result, the systems often transmit and store large volumes of low-value text data, thereby consuming significant network bandwidth, processor time, and memory resources on both server and client devices. This leads to latency in generating summaries and reduces the throughput of the overall system, particularly when processing many concurrent requests.

Second, conventional systems frequently apply generic summarization models directly to raw thread text without performing structural pruning or reordering of posts guided by machine-learned analysis. Because such models receive noisy, redundant, and poorly ordered input, they require more computational steps to generate an output of acceptable quality and may still produce summaries that are difficult for users to follow. Consequently, the computing resources of the generative model platform are used inefficiently, and response times degrade as the length and complexity of the source threads increase.

Third, known systems generally do not programmatically construct prompt sentences in a systematic, data-driven manner. Instead, static or manually designed prompts are used, which fail to incorporate detailed analysis results such as topic clusters, emotion indicators, and specific concepts that should be emphasized in the output article. Without such targeted prompt construction, the generative model may ignore critical technical concepts, fail to surface user-interest-driving elements, and produce articles that lack coherent structure. This leads to repeated invocations of the generative model or additional post-processing, thereby further increasing computational load.

Fourth, client devices, such as mobile terminals and head-mounted displays, must often receive and render either raw threads or verbose summaries that contain a high proportion of irrelevant or unstructured text. This not only increases communication overhead between server and terminal but also causes inefficient usage of display resources and user interface rendering pipelines. Users are forced to perform additional manual filtering and navigation operations, which in turn increases round-trip interactions with the server and further wastes computing and network resources.

Accordingly, there is a need for a technical solution that improves the way a computer system analyzes, edits, and summarizes anonymous discussion threads by: (i) computing structured analysis results including importance, topic, and conversation flow information; (ii) performing machine-guided pruning, reordering, and emphasis operations prior to summarization; and (iii) automatically generating context-aware prompt sentences tailored to a generative artificial intelligence model. Such a solution should reduce the volume of data processed by the generative model, improve the efficiency of model invocation, lower network and memory usage, and provide the terminal with a compact, machine-optimized article representation that is easier and faster to render. In this manner, the invention aims to provide an improvement to computer technology itself, namely, more efficient utilization of processing resources, communication resources, and storage resources in content summarization systems that employ generative artificial intelligence models.

The specific processing by the specific processing unit 290 of the data processing device 12 in Application Example 1 is realized by the following means.

The present invention provides a server comprising a processor configured to receive identification information of an anonymous posting information source from a terminal device; acquire, via a communication interface, a plurality of posting data from the anonymous posting information source; convert the acquired plurality of posting data into structured data; apply, by an analysis module executed by the processor and using natural language processing technology implemented by a machine-learned model, an analysis to the structured data to calculate importance information and topic information for each posting data and to generate analysis result data including conversation flow information and interest-evoking information; perform, based on the analysis result data, an editing process including a pruning process for deleting posting data having low importance, an order control process for reconstructing a display order of the posting data, and an emphasis-adding process for causing predetermined phrases to be displayed in an emphasized manner, thereby generating edited thread information; construct context data including the edited thread information and instruction information including article generation conditions and concepts to be emphasized; generate, based on the context data, a prompt sentence for causing a summary article of the edited thread information to be generated; input the prompt sentence and the edited thread information to a generative artificial intelligence model executed on a computing resource, and cause the generative artificial intelligence model to generate, as model output, the summary article reflecting contents of the edited thread information; and transmit the generated summary article to the terminal device and control output such that the terminal device displays the summary article in a viewable format. This enables the server to reduce the amount of low-value text supplied to the generative artificial intelligence model, to decrease computation and memory usage during summarization, to improve latency and throughput of summary generation, and to provide the terminal device with a compact, structured article that can be rendered with reduced communication overhead and improved usability, thereby achieving an improvement in overall computer system efficiency and performance in processing anonymous discussion threads.

The term “anonymous posting information source” refers to an electronic information source implemented by one or more computer systems, in which users can submit postings without identification of their real-world identity, such as an online discussion board, forum, or similar service that provides threads of user-generated text data.

The term “posting data” refers to digital data representing an individual contribution within a discussion provided by an anonymous posting information source, including at least a text body and optionally metadata such as a posting identifier, timestamp, and reply relationship information.

The term “structured data” refers to data that has been transformed from raw text and markup into a machine-readable format with an explicit structure, such as records, fields, and attributes, enabling programmatic access to elements including posting identifiers, text content, topic labels, and importance scores.

The term “natural language processing technology” refers to one or more software-implemented methods executed by a computer for analyzing, understanding, or generating human language, including tokenization, embedding computation, classification, clustering, sentiment analysis, keyword extraction, and summarization.

The term “analysis result data” refers to data generated by applying natural language processing technology to structured data, the analysis result data including, for each posting data, at least importance information and topic information, and further including conversation flow information and information indicating elements that are likely to attract user interest.

The term “importance information” refers to machine-computed data that represents a quantitative or qualitative measure of the relative significance of a posting data within a collection of postings, such as a score, rank, or label that indicates how useful or central the posting is to the discussion.

The term “topic information” refers to data indicating one or more subject matters associated with a posting data, such as topic labels, topic cluster identifiers, or probability distributions over topics derived from text analysis.

The term “conversation flow information” refers to data representing the logical or temporal sequence of postings within a thread, including reply relationships, transitions between topics, and ordering information that characterizes how the discussion progresses over time.

The term “interest-evoking information” refers to data that identifies or characterizes parts of posting data that are likely to attract user attention, such as humorous statements, emotionally charged comments, surprising facts, or highly referenced posts, as determined by machine analysis.

The term “pruning process” refers to an automated processing step in which posting data deemed to have low importance or low relevance, based on analysis result data, is selectively removed or excluded from further processing.

The term “order control process” refers to an automated processing step that reconstructs or rearranges the presentation order of posting data based on analysis result data, such as conversation flow information or topic information, to improve logical coherence or readability.

The term “emphasis-adding process” refers to an automated processing step that applies formatting or annotation to certain phrases or sections within posting data, such as highlighting, bolding, or otherwise marking concepts to be emphasized, so that they are more visually or structurally prominent in subsequent output.

The term “edited thread information” refers to data representing a discussion thread after completion of the pruning process, order control process, and emphasis-adding process, the edited thread information including a subset of the original posting data in a modified order and with emphasis metadata.

The term “context data” refers to data prepared for use as input to a generative artificial intelligence model, including at least the edited thread information and additional information such as constraints, parameters, and instructions that guide generation of a summary article.

The term “instruction information” refers to data specifying conditions for article generation, such as desired style, length, structure, and concepts to be emphasized, which is incorporated into a prompt sentence or otherwise provided to a generative artificial intelligence model.

The term “concepts to be emphasized” refers to specific ideas, terms, or entities within the edited thread information that are designated, based on analysis result data or system configuration, to be highlighted, described in greater detail, or otherwise given prominence in a generated summary article.

The term “prompt sentence” refers to one or more text strings provided as input instructions to a generative artificial intelligence model, the text strings describing a task to be performed, content to be considered, and constraints or preferences for the generated output.

The term “generative artificial intelligence model” refers to a machine-learned model implemented by software and executed on one or more processors, configured to generate new text data based on input text, including but not limited to large language models that produce natural language output from prompts.

The term “summary article” refers to a machine-generated text composed by a generative artificial intelligence model, which condenses, explains, or reorganizes the contents of edited thread information into a coherent narrative or expository form suitable for human reading.

The term “terminal device” refers to a user-operated computing device capable of communicating with a server and rendering information, such as a smartphone, tablet, personal computer, or head-mounted display.

The term “viewable format” refers to a representation of data that can be displayed on a terminal device for human perception, including but not limited to text formatted in markup languages, layout structures with headings and paragraphs, and styles that implement emphasis.

In the following embodiments, a server, a terminal, and a user cooperate to implement the claimed system. The server executes one or more programs stored in a non-transitory computer-readable storage medium. The terminal operates as a client device, and the user operates the terminal.

The server uses general-purpose computer hardware, for example, an information processing apparatus that includes at least one central processing unit (CPU), a main memory, a non-volatile storage device such as a solid-state drive (SSD), a network interface controller (NIC), and optionally a graphics processing unit (GPU) with a parallel computing framework. The server executes an operating system such as a Unix-like operating system and an application layer including an interpreter environment (for example, a Python runtime). The server executes libraries that implement a markup parser (for example, a hypertext markup parser library), an HTTP client (for example, a request handling library), and a natural language processing framework (for example, a transformer-based model framework).

The server uses a data structure in which each posting from an anonymous discussion thread is represented as a record containing at least a posting identifier, a timestamp, a text body, and optional reply reference information. The server stores such records in a structured format, such as an array of records in memory or in a database table. The server thereby converts raw HTML markup into structured data that can be processed by subsequent modules.

The server uses a natural language processing module implemented as a deep neural network model, for example, a transformer-based model including a plurality of self-attention layers, feedforward layers, layer normalization layers, and embedding layers. The server applies a tokenizer to each text body to convert sequences of characters into integer token identifiers. The server inputs the token identifiers and attention masks into the transformer model and computes, at each layer, weighted combinations of token representations using multi-head self-attention with trainable weight matrices. The server finally obtains, for each posting, an embedding vector that represents the semantic content of the posting.

The server calculates importance information using a classification head attached to the transformer model. The server uses a fully connected layer and a non-linear activation function to map the embedding vector to a scalar score between 0 and 1, indicating the importance of the posting within the thread. The server may train this classification head by gradient-based optimization, using a training set of postings labeled with levels of informativeness. The server may use a loss function such as binary cross-entropy or mean squared error, and the server updates model weights through backpropagation to reduce the loss on the training set.

The server calculates topic information by applying a clustering algorithm to the embedding vectors for the postings. In one embodiment, the server applies a k-means clustering algorithm that iteratively assigns embedding vectors to clusters and updates the cluster centroids to minimize within-cluster distance. In another embodiment, the server applies a topic model implemented as a probabilistic latent variable model, such as a model that estimates topic distributions over words and postings. The server stores, in the analysis result data, for each posting, the assigned cluster identifier or topic distribution.

The server calculates conversation flow information by analyzing reply relationships and temporal order of postings. The server constructs a directed graph in which each node corresponds to a posting and each directed edge represents a reply-to relationship. The server computes a topological ordering or other ordering of the nodes that respects reply dependencies and time stamps, thereby producing conversation flow information that indicates how the discussion proceeds. The server may also compute path lengths or branching factors in this graph and store such values as part of the conversation flow information.

The server calculates interest-evoking information by analyzing sentiment and lexical patterns in the postings. The server may use a sentiment classification model that outputs a polarity score or intensity score based on the embedding vector of each posting, and the server may also detect lexical features such as exclamation marks, certain idioms, or high-frequency user reactions. The server combines these features by a rule-based function or a learned regression model to generate a metric that indicates how likely the posting is to attract user interest.

The server performs a pruning process by comparing the importance information and the interest-evoking information for each posting against one or more thresholds. The server removes postings from the structured data if their combined score falls below a predetermined value, or if the length of the text body falls below a minimum character count, or if the posting belongs to a topic cluster that has very low overall importance. The pruning process reduces the size of the data that needs to be further processed, thereby reducing memory consumption and decreasing the amount of data that must be transmitted to downstream modules.

The server performs an order control process by reordering the remaining postings according to conversation flow information and topic information. The server may group postings by topic cluster and, within each group, order postings so that root postings (those without reply-to dependencies) appear before their replies. The server may also enforce an ordering that places explanatory postings before reaction postings, based on classification labels generated by the natural language processing module. This reordering improves the logical coherence of the edited thread information and reduces the need for the generative AI model to infer structure from noisy inputs.

The server performs an emphasis-adding process by inserting emphasis metadata into the text of postings. The server identifies concepts to be emphasized, such as references to a generative AI model, references to a prompt sentence, or key technical terms detected by keyword extraction algorithms. The server wraps such terms in markup tags or annotates them with emphasis flags in the structured representation. When the terminal renders the text, the terminal can display these concepts with distinct formatting, for example, different font weight or color.

The server thereby generates edited thread information that includes only a subset of the original postings, arranged in a machine-selected order, and annotated with emphasis metadata and topic associations. Because the server has removed low-importance content and reorganized the thread, the edited thread information constitutes a compact, structured representation that is significantly smaller than the original raw thread and more suitable for efficient processing by a generative AI model.

The server constructs context data that contains at least the edited thread information and instruction information. The instruction information specifies article generation conditions, such as a target length, tone, and structural constraints, and specifies concepts to be emphasized. The server then generates a prompt sentence by concatenating an instruction portion with the edited thread information and encoding, in natural language, the article generation conditions and the concepts to be emphasized.

The server can generate, for example, a prompt sentence of the following form:

“You are a professional writer. Read the edited posts from an anonymous discussion thread below. Using this content, generate a clear and concise summary article. Focus on the main discussion flow and key insights. Emphasize mentions of the generative AI model and the prompt sentence concepts. Organize the article with headings and short paragraphs. Preserve several short quotes that capture the tone of the discussion.

Edited Posts
[Post #123]
Generative AI model adoption is accelerating in multiple industries . . .
[Post #130]

Some users mention that designing an appropriate prompt sentence is becoming a critical skill . . . ”

The server, by generating the prompt sentence from concrete analysis result data, creates a tight coupling between the machine-derived structure of the thread and the instructions given to the generative AI model. Unlike a static manually written prompt, this generated prompt sentence encodes which topics and postings were determined to be important by the computer, and therefore enables the model to focus its computation on the most relevant content.

The server inputs the prompt sentence and at least part of the edited thread information as input to a generative AI model. The generative AI model may be implemented as a large-scale neural network using a transformer architecture with multiple layers, heads, and parameters. The server executes this model on an accelerator device, such as a GPU or specialized inference hardware, to compute for each input token a probability distribution over possible output tokens. The server samples or selects tokens according to this distribution to generate the summary article text. Because the input length has been reduced by the pruning process and structured by the order control process, the model can generate the article using fewer internal computations, and the hardware can perform the generation with lower latency and reduced memory usage.

The server may train or fine-tune the generative AI model by providing pairs of edited thread information and desired summary articles. The server uses a loss function such as cross-entropy between the generated token sequence and the reference sequence, and updates the model by gradient-based optimization. The server may employ techniques such as teacher forcing during training, learning rate scheduling, and regularization to improve convergence. The server may also perform data augmentation by simulating different pruned and reordered views of the same source thread to increase robustness of the model.

The server transmits the generated summary article to the terminal over a communication network using a protocol such as HTTP over TCP/IP. The summary article is notably smaller in size than the original thread, so the communication payload is reduced, thereby lowering network load and transmission time. The terminal receives the summary article and parses its structure. The terminal then renders the article using its user interface framework, for example, by displaying headings, paragraphs, and emphasized terms. In a head-mounted display, the terminal can position the text in three-dimensional space with stable framerate because the amount of text to render is controlled and limited, improving overall device performance.

The user operates the terminal to select a thread to be summarized, to request updated summaries with different constraints, or to navigate between sections of the summary article. The user does not manually filter unreadable or irrelevant postings, because the server has already removed such postings through the pruning process. The user can therefore consume information more quickly, with fewer interactions and reduced visual clutter.

The server thereby achieves several technical effects. First, by computing embedding vectors, importance scores, and topic clusters, and by using these to prune and reorder data before invoking the generative AI model, the server significantly reduces the volume of input data and removes redundancy. This leads directly to reduced computation time and memory usage inside the generative AI model. Second, by structuring the input in a way that encodes conversation flow and topic grouping, the server allows the model to generate more coherent output with fewer decoding steps, improving both the quality and speed of the generated summaries. Third, by generating prompt sentences programmatically from analysis result data, the server maintains a dynamic and optimized interaction protocol with the generative AI model, leading to improved accuracy of the generated articles and reduced need for repeated invocations.

The server thereby improves computer technology itself, not merely by automating human summarization work, but by optimizing memory access patterns, reducing network bandwidth usage, and decreasing load on inference hardware. The server uses internal rules and model-based criteria that are not equivalent to human cognitive steps. For example, the server uses distance metrics in embedding space, clustering algorithms, threshold-based pruning rules, and graph-based ordering that rely on numerical computations and data structures that humans do not naturally use when reading text. The server also performs non-conventional processing such as combining sentiment scores with reply graph features to determine which postings are likely to be important for summary generation.

The server can be implemented in multiple embodiments. In one embodiment, the server uses a single monolithic transformer model for both analysis and generation. In another embodiment, the server uses a smaller transformer classifier for analysis and a larger generative transformer for article generation, thereby separating the tasks and allowing optimization of each model. In yet another embodiment, the server employs a recurrent neural network or convolutional network in combination with transformer layers for analysis when computational resources are limited.

The server may also store intermediate analysis result data in a database so that repeated requests for summaries of the same thread can be served without re-running the full analysis, further reducing computational load. The server may adjust pruning thresholds based on system load conditions, thereby dynamically trading off summary completeness against computational cost.

The terminal can be implemented as a mobile communication device, a desktop computing device, or a wearable device. The terminal may cache previously received summaries to reduce repeated network requests. The terminal may also send feedback signals to the server indicating which parts of the summary the user actually viewed or interacted with. The server may use such signals to adjust future pruning and emphasis rules, thereby further improving technical performance and output relevance.

The user may select different modes, such as a “technical detail” mode that instructs the server to relax pruning for posts that contain numerical data or code-like text, or a “high-level overview” mode that instructs the server to further restrict content to high-importance postings. The server, in response, modifies thresholds and instruction information in the context data, giving rise to different prompt sentences and thus different model outputs, while still preserving the same core processing pipeline.

Through these embodiments, the server, the terminal, and the user collectively realize the claimed system in a way that is implementable on conventional hardware but that provides improved processing efficiency, improved accuracy of summarization, and reduced communication and rendering load, thereby concretely improving the performance of computer systems that handle large volumes of anonymous discussion data with a generative AI model and a structured prompt sentence.

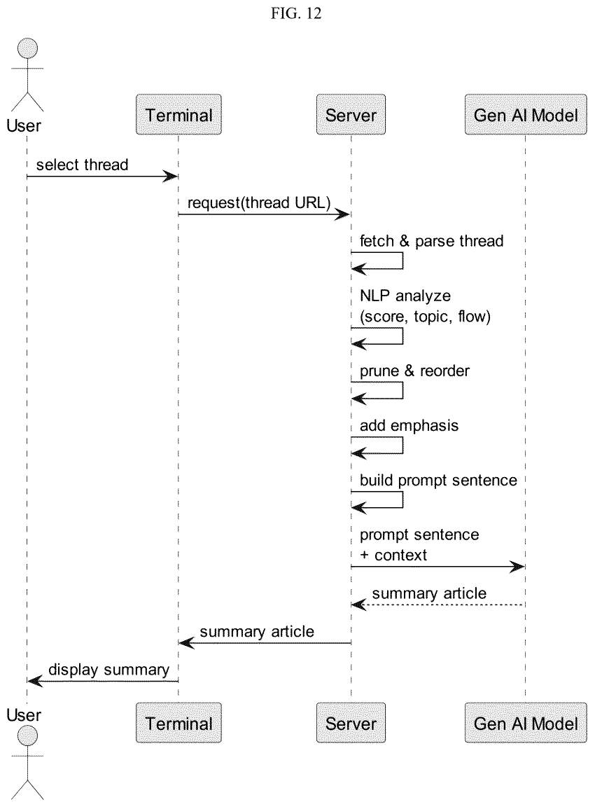

The following describes the processing flow using FIG. 12.

### Step 1

The user operates the terminal to specify a target anonymous discussion thread.

The terminal sends, as input to the server, a request including at least a thread identifier or a thread URL.

The server receives the request, parses the input parameters, validates the format of the identifier or URL, and outputs a normalized thread request object containing a canonical thread identifier and access parameters.

### Step 2

The server uses the normalized thread request object as input to access the anonymous posting information source via a communication interface.

The server transmits an HTTP request or an application protocol request to the information source and receives, as raw output, markup data such as HTML or structured page data describing the thread.

The server outputs the received raw page data as a page content object for further processing.

### Step 3

The server takes the page content object as input and performs parsing and extraction.

The server applies a markup parser to the raw page data to locate elements corresponding to individual postings, such as post containers, identifiers, timestamps, and text bodies.

The server performs data processing by stripping tags, decoding character entities, and normalizing whitespace, thereby generating, as output, a structured posting list in which each element is a record containing a posting identifier, a timestamp, optional reply reference information, and a text body.

### Step 4

The server uses the structured posting list as input to a natural language preprocessing module.

The server segments the text bodies into tokens by applying a tokenizer associated with a deep learning model, maps tokens to integer identifiers, and constructs input sequences with attention masks.

The server outputs, for each posting, a tokenized representation that includes token identifiers, segment identifiers if applicable, and attention masks ready for model inference.

### Step 5

The server uses the tokenized representations as input to an analysis model implemented as a transformer-based neural network.

The server performs data computation by propagating the token embeddings through multiple self-attention layers and feedforward layers, computing contextualized embeddings for tokens and aggregating them to obtain an embedding vector for each posting.

The server outputs, for each posting, an embedding vector representing the semantic content of the posting.

### Step 6

The server takes the posting embedding vectors as input to an importance scoring module.

The server applies a fully connected layer and an activation function to each embedding vector and computes a scalar importance score, optionally normalizing the scores across the thread.

The server outputs a set of importance information values, each associated with a corresponding posting identifier.

### Step 7

The server takes the posting embedding vectors as input to a topic analysis module.

The server performs clustering or topic modeling by grouping embedding vectors based on distance metrics or probabilistic topic distributions, computing cluster centroids or topic probabilities, and assigning each posting to one or more topics.

The server outputs topic information, including cluster identifiers or topic labels for each posting and a list of overall topics detected in the thread.

### Step 8

The server uses the structured posting list, timestamps, and reply reference information as input to a conversation flow analysis module.

The server constructs a directed graph whose nodes correspond to postings and whose edges represent reply relationships; the server uses timestamps to sort postings and resolves conflicts to derive a sequence that reflects both reply dependencies and temporal order.

The server outputs conversation flow information, including an ordered list of posting identifiers and graph features such as parent-child relationships and thread branch points.

### Step 9

The server uses the posting embedding vectors and the structured posting list as input to an interest-evoking scoring module.

The server computes sentiment scores from the embeddings using a sentiment classifier, extracts lexical features such as punctuation patterns and emphasis phrases, and combines these features using a rule-based or learned function to obtain an interest score for each posting.

The server outputs interest-evoking information as a set of scores or labels indicating which postings are likely to attract user attention.

### Step 10

The server uses the importance information and the interest-evoking information as input to a pruning controller.

The server performs data filtering by comparing scores against one or more thresholds, discarding postings with low importance and low interest, and optionally enforcing minimum coverage per topic and maximum total number of postings.

The server outputs a pruned posting subset, which is a reduced set of postings selected for further processing.

### Step 11

The server uses the pruned posting subset and the conversation flow information as input to an order control module.

The server rearranges the postings by grouping them according to topic information, ordering root postings before replies, and aligning explanatory postings before reaction postings based on classification labels or structural features.

The server outputs an ordered posting sequence that defines the sequence in which the selected postings will appear in the edited thread.

### Step 12

The server uses the ordered posting sequence and topic information as input to a sectioning module.

The server creates logical sections by inserting boundaries where topic changes occur and by grouping postings belonging to the same topic into contiguous segments.

The server outputs sectioned thread data that includes section headers referencing topics and a mapping from postings to sections.

### Step 13

The server uses the sectioned thread data and a list of concepts to be emphasized as input to an emphasis-adding module.

The server searches the text bodies of the selected postings for terms corresponding to the concepts to be emphasized, such as references to a generative AI model or a prompt sentence, and wraps these terms with emphasis markers such as tags or special tokens.

The server outputs edited thread information in which each posting is associated with emphasis metadata and section identifiers.

### Step 14

The server uses the edited thread information and system configuration parameters as input to an instruction generation module.

The server composes article generation conditions including desired length, writing style, section structure, and emphasis requirements, and encodes these conditions as instruction information in natural language.

The server outputs an instruction text block that will be used as part of the prompt sentence.

### Step 15

The server uses the instruction text block and the edited thread information as input to a prompt construction module.

The server concatenates a role description, the instruction text block, and the edited postings with section headers into a single text sequence, inserting delimiters and labels to mark post identifiers and sections.

The server outputs a prompt sentence that precisely describes the summarization task, specifies the concepts to be emphasized, and embeds the edited thread information as contextual content.

### Step 16

The server uses the prompt sentence and, optionally, the edited thread information as input to a generative AI model based on a transformer decoder or encoder-decoder architecture.

The server performs data computation by encoding the prompt sentence, attending over the encoded representations, and iteratively predicting output tokens while updating the model's internal states until an end-of-sequence condition is met.

The server outputs a generated token sequence, which is converted into text forming a summary article.

### Step 17

The server uses the generated summary article text as input to a post-processing module.

The server performs formatting operations such as inserting headings, normalizing whitespace, ensuring that emphasis markers are consistent with terminal capabilities, and truncating or segmenting the article if length limits apply.

The server outputs a final summary article object that contains the processed text and layout metadata ready for transmission.

### Step 18

The server uses the final summary article object and the original request information as input to a response generation module.

The server wraps the article text and related metadata, such as title, thread identifier, and generation timestamp, into a response message in a predetermined format suitable for the terminal.

The server outputs a response payload that is transmitted over the communication network to the terminal.

### Step 19

The terminal receives the response payload from the server as input through a communication interface.

The terminal parses the payload to extract the summary article text and layout metadata, maps emphasis markers to display styles, and prepares user interface elements such as headings, paragraphs, and highlighted phrases.

The terminal outputs a rendered article view on its display device, allowing the user to visually perceive the summarized content.

### Step 20

The user interacts with the rendered article view displayed by the terminal.

The user scrolls, selects sections, or issues further commands such as requesting more detail on a particular topic, and the terminal collects these interaction signals as input.

The terminal outputs updated requests or feedback messages to the server, which can be used in subsequent executions of the processing pipeline to adjust pruning thresholds, emphasis rules, or prompt sentence construction for improved future summaries.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional content summarization systems that create articles from online discussion threads suffer from several technical limitations when implemented on general-purpose computer hardware. First, such systems typically perform only shallow text extraction and rule-based summarization, without structurally reorganizing large volumes of thread data according to semantic importance and topic relationships. As a result, the underlying computing resources are used inefficiently: processors waste cycles processing low-relevance posts, storage and memory are occupied by redundant or noisy data, and network bandwidth is consumed by transferring unnecessarily large result sets to user terminals.

Second, in many existing architectures, natural language processing components and generative models are invoked in an ad hoc, one-shot manner. A single unstructured prompt is often sent to a generative model with raw or minimally filtered thread text. This monolithic invocation does not exploit intermediate, machine-usable structures such as topic clusters, importance scores, and post-level features. Consequently, the generative model must internally re-derive context and importance, leading to increased latency, unstable output quality, and inefficient utilization of model inference resources.

Third, prior systems generally do not separate an “analysis phase” from a subsequent “generation phase” in a way that is explicitly encoded and controlled at the level of prompt design and data flow. Without a well-defined analysis-dedicated prompt and generation-dedicated prompt, the system cannot systematically reuse structured analysis results, cannot reliably align generated summaries with objectively important posts, and cannot expose machine-readable links between summary segments and their evidentiary source posts. This lack of structure impedes downstream processing, such as explanation, traceability, and interactive refinement, and prevents efficient scaling of the system across large numbers of threads.

Fourth, user terminals typically receive only a final free-form article, without associated machine-readable metadata linking each summary portion back to specific important posts and topic clusters. This limits the ability of client-side applications to render enhanced interfaces (for example, highlight views, drill-down navigation, or confidence indicators) and forces redundant server-side computations when users request alternative views or levels of detail.

Accordingly, there is a need for an improved computer-implemented system and method that: (i) automatically acquires thread information and converts it into structured data; (ii) performs multi-stage natural language processing to generate feature information and topic information; (iii) edits and reorders posts based on importance and relatedness; (iv) constructs analysis-dedicated and generation-dedicated prompt sentences for a generative language model in a coordinated, machine-controlled manner; and (v) returns both a summary article and associated structured metadata to the user terminal. Such a system should improve the technical efficiency and reliability of processing large-scale thread data on general-purpose computing platforms, reduce unnecessary computation and data transfer, and provide a more stable and explainable use of a generative AI model.

The specific processing by the specific processing unit 290 of the data processing device 12 in Example 2 is realized by the following means.

The present invention provides a server comprising a processor and a communication interface, the processor being configured to acquire thread information from an information source via a communication network based on identification information received from a user terminal, parse markup-language data of the acquired thread information to generate structured data representing post-level text data and metadata, execute a multilayer natural language processing pipeline on the structured data to generate feature information for each post and topic information for an entire thread, execute an editing process to calculate relatedness between posts, determine importance scores and topic clusters, select or prune posts based on the importance scores, reconstruct an order of the posts in at least one of a chronological order and a topic-based order, and generate edited thread information including emphasis information indicating important portions, generate a first analysis-dedicated prompt sentence for a generative language model based on the edited thread information, the first prompt sentence defining a role, an output format, and return data items for analyzing the thread and causing the generative language model to output structured analysis results including at least one of topic lists, important post sets, and episode descriptions, generate a second generation-dedicated prompt sentence for the generative language model based on the edited thread information and the structured analysis results, the second prompt sentence defining an article structure, a writing style, and a summarization policy for generating article text summarizing the entire thread, cause the generative language model to execute an article generation process in response to the second prompt sentence, and convert the generated article text and the edited thread information into display data and transmit the display data to the user terminal via the communication interface. This enables the server to efficiently transform large-scale unstructured thread data into structured intermediate representations, control the behavior of the generative AI model through explicitly defined analysis and generation prompt sentences, reduce redundant computation by reusing structured analysis results, improve latency and resource utilization on general-purpose computer hardware, and provide the user terminal with both a coherent summary article and machine-readable metadata that support traceable, explainable, and interactively refinable presentation of the underlying discussion content.

The term “processor” refers to a hardware computation unit or a combination of hardware computation units, such as a central processing unit or a graphics processing unit, that executes machine-readable instructions to perform logical and arithmetic operations.

The term “communication network” refers to a wired or wireless data transmission infrastructure, including at least one of a local area network and a wide area network, through which digital information is exchanged between the server and external devices such as user terminals and information sources.

The term “user terminal” refers to an information processing device operated by a user, such as a personal computer, a tablet device, or a smartphone, that is configured to transmit identification information of an information source to the server and to receive and display output data from the server.

The term “information source” refers to a data-providing system accessible via the communication network, including at least one of a web server, a database server, and an application server, that stores or provides thread information or other content to be processed by the server.

The term “identification information” refers to data used to specify an information source or a particular resource within the information source, including at least one of a uniform resource locator, a uniform resource identifier, and an internal resource identifier.

The term “thread information” refers to digital data representing a collection of related posts or messages, typically organized in a chronological or reply-based sequence, obtained from an information source such as an online discussion board or a comment system.

The term “standardized data format” refers to a data representation format having a predetermined structure, such as a markup language structure or a structured text format, that enables consistent parsing and processing of the thread information by the processor.

The term “markup-language data” refers to text data that includes structural or semantic annotations using tags or similar constructs, such as those defined by a markup language, to describe the organization and content of the thread information.

The term “post-level text data” refers to text content extracted from the thread information for each individual post or message, excluding structural markup and unrelated control information.

The term “metadata” refers to auxiliary information associated with each post, including at least one of a post identifier, a timestamp, an author identifier, and reply relationship information.

The term “structured data” refers to data that is organized into a defined schema, such as records, fields, and relationships, allowing systematic access, analysis, and modification by the processor.

The term “string normalization” refers to a text preprocessing operation that converts character sequences into a canonical form, including at least one of unifying character encodings, adjusting letter case, normalizing punctuation, and removing extraneous whitespace.

The term “sentence segmentation” refers to a text processing operation that detects sentence boundaries in a text sequence and divides the text into individual sentences according to linguistic rules or statistical models.

The term “language-processing library” refers to a software component or collection of software components that provide functions for natural language processing, including at least one of tokenization, part-of-speech tagging, and named entity recognition.

The term “natural language processing technique” refers to a computational method or algorithm that enables the processor to analyze, interpret, or transform human language text, including at least one of morphological analysis, syntactic analysis, semantic analysis, and sentiment analysis.

The term “morphological analysis” refers to a linguistic processing operation that decomposes text into morphemes or tokens and identifies their base forms and grammatical attributes.

The term “part-of-speech tagging” refers to an annotation process that assigns grammatical categories, such as noun, verb, or adjective, to tokens in a text sequence.

The term “named entity extraction” refers to a process that detects and classifies expressions in text that refer to real-world entities, including at least persons, organizations, locations, and products.

The term “sentiment determination” refers to an analysis operation that estimates an emotional or evaluative polarity of text, such as positive, negative, or neutral sentiment, based on lexical, syntactic, or statistical features.

The term “term frequency calculation” refers to a statistical operation that counts or otherwise quantifies occurrences of words or phrases within a text corpus or a subset of the corpus.

The term “feature information” refers to numerical or categorical values computed from text or metadata, representing characteristics of posts or threads, including at least one of term frequencies, sentiment scores, and entity occurrence counts.

The term “topic information” refers to data indicating one or more themes or subjects that appear within a thread, typically derived from statistical or semantic analysis of the posts.

The term “analysis process” refers to a sequence of computational operations executed by the processor to derive feature information and topic information from preprocessed text data and structured data.

The term “editing process” refers to a sequence of computational operations executed by the processor to modify, filter, and reorder posts based on feature information and topic information, thereby generating edited thread information.

The term “relatedness between posts” refers to a measure of similarity or connection between two or more posts, computed based on factors such as shared terms, semantic similarity, reply relationships, or topic similarity.

The term “importance score” refers to a numerical or categorical value assigned to each post to represent its relative significance within a thread, computed using feature information, topic information, or analysis results from a generative language model.

The term “topic cluster” refers to a group of posts classified as being related to a common topic, based on similarity measures or clustering algorithms applied to feature information and topic information.

The term “edited thread information” refers to thread information that has been processed through the editing process to include a selected subset of posts, a reconstructed order of posts, and additional metadata such as emphasis information.

The term “emphasis information” refers to metadata or annotations indicating that a particular text portion, post, or segment is important, such as flags, scores, or markup tags used for highlighting.

The term “generative language model” refers to a machine learning model configured to generate natural language text in response to input data and a prompt sentence, including models based on neural network architectures.

The term “prompt sentence” refers to input text that specifies instructions, context, and constraints for a generative language model, thereby guiding the generation or analysis performed by the model.

The term “first prompt sentence” refers to a prompt sentence designed primarily for analysis of thread information, configured to instruct the generative language model to output structured analysis results such as topic lists and important post sets.

The term “second prompt sentence” refers to a prompt sentence designed primarily for generation of an article, configured to instruct the generative language model to produce article text summarizing the thread in a structured form.

The term “analysis-dedicated prompt sentence” refers to a type of first prompt sentence that explicitly defines a role of the generative language model, an output format, and return data items for performing analysis tasks including at least one of topic extraction, important post extraction, and episode extraction.

The term “generation-dedicated prompt sentence” refers to a type of second prompt sentence that explicitly defines an article structure, topics to be explained, an order of presentation of important episodes, and style conditions for generating article text.

The term “structured analysis result” refers to machine-readable output produced by the generative language model in response to an analysis-dedicated prompt sentence, including at least one of a topic list, an important post set, and an episode description.

The term “article structure” refers to a logical organization of article text into sections or parts, including at least an introduction part, a body part, and a conclusion part.

The term “writing style” refers to a set of constraints or preferences regarding how the generative language model should express text, including at least tone, formality level, and narrative style.

The term “summarization policy” refers to rules or guidelines that specify how the generative language model should condense and select information from the thread to generate a summary article, including at least target length and focus on certain topics or episodes.

The term “article text” refers to textual output generated by the generative language model in response to the second prompt sentence, representing a coherent summary or narrative of the thread.

The term “article generation process” refers to operations performed by the generative language model to produce article text based on the second prompt sentence and associated input data.

The term “display data” refers to data formatted for presentation on a user terminal, including at least text layout information, markup, and highlighting instructions derived from the article text and edited thread information.

In one embodiment, a server executes the claimed system on a general-purpose computing platform. The server includes at least one central processing unit (CPU), such as a multi-core x86 or ARM processor, volatile memory such as dynamic random access memory (DRAM), non-volatile storage such as a solid-state drive (SSD), and a network interface controller enabling communication over a wired or wireless communication network. In another embodiment, the server further includes a graphics processing unit (GPU), such as a programmable GPU supporting general-purpose computation, to accelerate execution of neural network models. The server executes an operating system, such as a UNIX-like operating system, and middleware including a runtime environment for a high-level programming language such as Python. The server further executes software components, including a web framework, an HTTP client library, a markup-language parser, and natural language processing libraries such as a tokenization library and an entity-recognition library.

The server uses a web framework, such as an HTTP application framework, to expose an application programming interface (API) endpoint to a terminal. The terminal is an information processing device, such as a personal computer or a smartphone, executing a web browser or a dedicated client application. The user operates the terminal to input identification information of an information source, for example a uniform resource locator identifying a thread on an online discussion service. The terminal transmits the identification information to the server over the communication network.

The server uses an HTTP client library such as a request library and, when dynamic rendering is required, an automated browser component such as a headless browser controlled by a browser automation framework, to acquire markup-language data from the information source. The server receives the markup-language data as a sequence of bytes, decodes the sequence into a character string, and stores the character string in memory. The server then uses a markup-language parser such as a document object model parser to analyze the tree structure of the markup-language data. The server identifies structural elements representing posts by applying predetermined selection rules, such as matching tag names and attribute values corresponding to post containers, timestamp fields, author identifiers, and reply references.

The server extracts post-level text data by traversing the markup-language tree, stripping markup tags, and concatenating textual nodes within the post containers. The server simultaneously extracts metadata, including post identifiers, timestamps, and reply references, by locating and reading attribute values or specific sub-elements. The server aggregates the text data and the metadata for each post into a structured data record. In one embodiment, the server represents each post as a record in a tabular data structure or as a key-value mapping in memory. This explicit structured representation enables subsequent processing modules to access and manipulate post-level information efficiently without re-parsing markup-language data, thereby reducing processor cycles and memory overhead.

The server performs preprocessing operations on the extracted text. The server normalizes strings by converting characters to a canonical encoding form, adjusting letter case according to a predetermined rule, standardizing punctuation, and removing redundant whitespace. The server performs sentence segmentation using a natural language processing library, which applies rules or probabilistic models to identify sentence boundaries and divide the text into discrete sentences. The server stores, for each post, the tokenized sentences and the mapping between sentences and the original text spans. This stabilizes later computations of importance and relatedness by ensuring consistent sentence boundaries and tokenization.

The server applies a natural language processing technique to the preprocessed text by invoking a language-processing library such as a part-of-speech analysis module, a named entity recognition module, and a sentiment analysis module. The server performs morphological analysis or tokenization to split each sentence into tokens, assigns part-of-speech tags to each token, and detects named entities with associated entity types such as person, organization, location, and product. The server further computes sentiment scores for each post by applying a sentiment analysis model, for example a machine-learning classifier trained on labeled sentiment data. The server calculates term frequencies by counting the occurrences of tokens and phrases within each post and across the entire thread. The server organizes these outputs into feature vectors, where each vector component corresponds to a measurable property such as token count, sentiment score, or entity frequency.

The server derives topic information by applying a topic analysis method to the feature vectors. In one embodiment, the server performs clustering using an unsupervised algorithm such as k-means or hierarchical clustering on vector representations of posts. In another embodiment, the server computes sentence or post embeddings using a neural network-based encoder, such as a transformer encoder, and applies a similarity measure such as cosine similarity to group posts into topic clusters. The server stores, for each post, a topic cluster identifier and relatedness scores to other posts, such as similarity values or distances in an embedding space. By operating on dense numerical representations rather than raw text, the server improves computational efficiency and reduces the dimensionality of data processed in subsequent stages.

The server executes an editing process that selects, prunes, and reorders posts based on computed importance scores and topic relationships. The server calculates an importance score for each post as a weighted combination of multiple feature components, such as term frequencies of keywords, entity counts, sentiment intensity, cluster centrality measures, and reply relationships (for example, a count of references from other posts). The server may further incorporate information derived from prior invocations of a generative AI model, such as model-assigned salience scores, to refine the importance scores. The server discards posts whose importance scores fall below a threshold, thereby reducing the amount of data processed in later stages and lowering memory and bandwidth requirements. The server then reconstructs an order of the remaining posts based on one or more criteria, such as chronological order within each topic cluster or an order that follows a narrative sequence derived from relatedness scores. The server marks segments of text corresponding to high-importance sentences or phrases by attaching emphasis information, such as flags or markup indicators, to these segments.

The server employs a generative AI model implemented as a neural network, for example a transformer-based language model composed of multiple self-attention layers, feed-forward layers, and normalization layers. The model parameters, including weight matrices and bias vectors, are trained on large-scale text corpora using a pre-training objective such as masked language modeling or next-token prediction. The server optionally performs fine-tuning on domain-specific thread data to adapt the generative AI model to the style and vocabulary of online discussions. During training, the server uses an optimization algorithm such as stochastic gradient descent with adaptive learning rate methods, a loss function such as cross-entropy loss between predicted tokens and ground-truth tokens, and regularization techniques such as dropout. Weight updates are calculated based on gradients of the loss function with respect to model parameters, and the server applies backpropagation through the network layers.

The server utilizes the generative AI model at inference time not as an opaque component, but as a controlled text processor guided by precisely constructed prompt sentences. The server generates a first prompt sentence, referred to as an analysis-dedicated prompt, based on the edited thread information. The server assembles selected post texts, topic labels, importance scores, and emphasis information into a structured context, and prefixes this context with explicit instructions describing the role of the model, the required output fields, and the format of the response. For example, the server may generate a first prompt sentence as follows:
“You are an assistant that analyzes anonymous discussion threads.
Thread content (edited and highlighted):
(important) ‘Text of the first key post . . . ’
(related to Topic A) ‘Text of the second post . . . ’
(high sentiment) ‘Text of the third post . . . ’
. . .
Task:
Identify the main discussion topics in this thread.
Extract the most important posts.
Describe the most interesting episodes.
Return a structured description listing: topics, important posts, and episodes.”

By including importance and topic annotations, the server constrains the generative AI model to focus on relevant content, reduces ambiguity in the model's internal attention patterns, and stabilizes the output format. This improves inference efficiency and output reliability, thereby constituting an improvement in the technical operation of the model on the server hardware.

The server parses the structured analysis results returned by the generative AI model, such as lists of topics, mappings from topics to post identifiers, and textual descriptions of episodes. The server integrates these results into its internal data structures, augmenting feature information and topic information with model-derived semantic groupings. This reuse of structured results avoids reprocessing raw text in subsequent operations, thereby reducing computational load and enabling incremental updates when only portions of the thread change.

The server generates a second prompt sentence, referred to as a generation-dedicated prompt, to instruct the generative AI model to produce an article summarizing the thread. The server composes the second prompt sentence by specifying an article structure, including an introduction part, a body part, and a conclusion part, and by embedding condensed versions of the edited thread information and analysis results. For example, the server may generate a second prompt sentence as follows: “You are a writer summarizing an online discussion thread for a general audience.

Edited thread summary:
Topic 1:‘Buying a used device and initial problems.’
Key posts: #3, #7, #12
Key episode: ‘The unexpected behavior when checking the serial number.’
Topic 2:‘Debate about whether the device is defective or misconfigured.’
Key posts: #15, #20, #24
Using this information:
Write an article in English with an introduction, a body, and a conclusion.
Explain the background of the thread.
Describe the most interesting episodes in a narrative style.
Present the main points of debate and any conclusions.
Use a neutral, informative tone.”

The server feeds the second prompt sentence into the generative AI model. Because the prompt sentence explicitly constrains structure and content, the model generates article text that is aligned with the previously computed importance scores and topic clusters. The server receives the output tokens, reconstructs the article text as a character string, and stores it together with references to the underlying important posts. The server then converts the article text and edited thread information into display data, such as markup-language content with paragraph tags, headings, and highlight tags.

The terminal receives the display data from the server and renders it on a display device. The terminal may display the article text in one area and, in response to user interaction, dynamically highlight or reveal the corresponding original posts based on the associations transmitted by the server. By providing both the article and machine-readable links to source posts, the system enables interactive exploration, which makes use of the structured metadata generated by the server's specialized processing pipeline.

This architecture improves computer technology in several ways. First, the server reduces redundant processing by separating an analysis phase and a generation phase and by capturing structured analysis results that can be reused for multiple generation tasks, such as generating summaries of different lengths or focus. Second, the use of explicit importance scores, topic clusters, and emphasis information allows the server to prune irrelevant content before invoking the generative AI model, thereby reducing the number of tokens processed by the model, reducing GPU computation time, and lowering overall inference latency. Third, the construction of analysis-dedicated and generation-dedicated prompt sentences provides a deterministic control interface between classical natural language processing modules and the generative AI model, improving consistency and predictability of outputs and allowing the server to implement non-standard, model-aware control flows that are not achievable by simple human prompting. Fourth, by storing and transmitting structured metadata together with generated text, the server reduces the need for client-side re-analysis and supports efficient, fine-grained rendering operations on the terminal, thus lowering network bandwidth usage and enabling responsive user interfaces.

The server applies rules and algorithms that differ from conventional human summarization procedures. For example, the server combines numerical clustering of vector embeddings, importance scoring with multi-dimensional feature vectors, and a two-stage neural text generation pipeline controlled by machine-generated prompt sentences. Human operators typically cannot manually construct and manage such high-dimensional feature spaces, nor can they consistently define and reuse structured prompt interfaces across large numbers of threads. The system thus implements a non-conventional technical workflow tuned to the characteristics of neural network inference and networked data retrieval, rather than merely automating a human editorial process.

In alternative embodiments, the server may employ different generative AI model architectures, such as a sequence-to-sequence recurrent neural network or a convolutional language model, provided that the model accepts prompt sentences and produces text outputs token-by-token. The server may adjust hyperparameters such as context window size, token sampling temperature, and output length based on available hardware resources and quality requirements. The server may also replace particular natural language processing libraries with functionally equivalent components, such as alternative tokenizers, sentiment analyzers, or embedding generators, without departing from the fundamental data flow in which the server performs preprocessing, feature extraction, topic clustering, editing, prompt construction, model invocation, and display data generation.

In another embodiment, the server operates in a distributed configuration, where one processing node is specialized for markup parsing and feature extraction, another node is specialized for topic clustering and importance scoring, and yet another node hosts the generative AI model on GPU-equipped hardware. The nodes communicate via a message queue or a remote procedure call interface, passing structured data rather than raw text wherever possible to reduce network load. This modular architecture allows scaling of each component independently and further reduces resource contention.

By explicitly defining internal data structures, processing modules, and model-control prompt sentences, and by tightly coupling these components to the underlying hardware configuration, the system realizes technical effects such as faster processing of large volumes of thread data, more accurate selection of important content, improved stability of generated summaries, and reduction of network and memory usage. These improvements arise from the specific manner in which the server orchestrates classical natural language processing operations, numerical clustering algorithms, and controlled neural text generation, rather than from mere automation of a mental process or a high-level business routine.

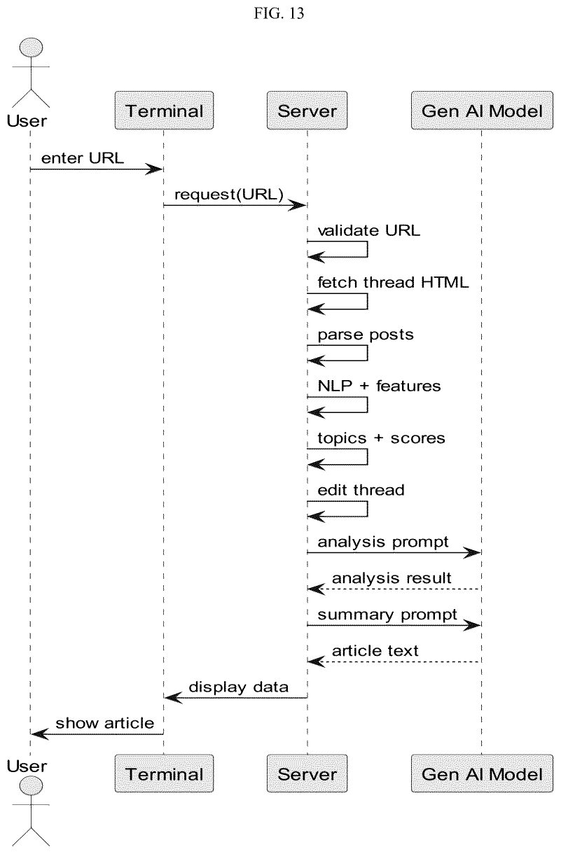

The following describes the processing flow using FIG. 13.

### Step 1

The user operates the terminal to open an application and input identification information of an information source, such as a URL of an online discussion thread, into an input field.

Input: User's keystrokes and pointer operations on the terminal, representing the thread URL or other identification information.

Output: A request message including the identification information and optional parameters (for example, desired summary length, language) transmitted from the terminal to the server over a communication network.

The terminal packages the identification information and parameters into an HTTP or HTTPS request and sends the request to an API endpoint exposed by the server.

### Step 2

The server receives the request from the terminal via a network interface and validates the identification information.

Input: The HTTP request containing the thread URL and user parameters.

Output: A validated and normalized request object stored in the server's memory, or an error response if the URL is invalid.

The server parses the request headers and body, checks the URL format using a URL parsing library, verifies that the domain is allowed, and records the request in a log data structure. The server discards malformed requests and returns an error message to the terminal when necessary.

### Step 3

The server accesses the information source and acquires markup-language data corresponding to the specified thread.

Input: The validated thread URL and optional access parameters (for example, cookies, headers).

Output: Raw markup-language content (for example, HTML text) of the thread page stored as a character string in memory.

The server uses an HTTP client library to send a GET request to the information source. If the page requires client-side rendering, the server launches a headless browser controlled by a browser automation framework, waits for dynamic content to load, and then retrieves the rendered markup-source. The server decodes the received byte stream using the appropriate character encoding.

### Step 4

The server parses the markup-language data to extract post-level text data and metadata.

Input: The markup-language character string representing the thread page.

Output: A collection of structured post records, each containing post text and associated metadata.

The server invokes a markup parser to construct a document object model tree. The server applies selection rules specifying tag names and attributes that identify post containers, timestamps, author fields, and reply references. The server traverses the tree to strip markup tags from post containers and concatenates text nodes into a single text string for each post. The server reads attributes or child elements to obtain post identifiers, timestamps, and reply relationships, and stores the extracted information in a structured format such as a list of records.

### Step 5

The server performs text preprocessing on the extracted post texts.

Input: The collection of structured post records with raw text and metadata.

Output: Updated post records containing normalized text and segmented sentences linked to the original text spans.

The server executes string normalization routines to unify character encodings, adjust letter case, standardize punctuation, and remove extraneous whitespace. The server applies sentence segmentation algorithms from a natural language processing library to divide each post text into individual sentences. The server associates each sentence with its position in the original text so that later highlighting and emphasis marking can reference the correct spans.

### Step 6

The server applies a natural language processing pipeline to generate feature information for each post.

Input: Normalized post texts and sentence lists for each post.

Output: Feature vectors and annotations for each post, including tokens, part-of-speech tags, named entities, sentiment scores, and term frequencies.

The server uses a tokenizer to split sentences into tokens, assigns part-of-speech tags using a tagging model, and identifies named entities and their types using an entity recognition model. The server computes sentiment scores for each post with a sentiment classifier, and counts occurrences of tokens and phrases to calculate term frequencies at both post level and thread level. The server aggregates these results into feature vectors stored alongside the post records.

### Step 7

The server derives topic information and relatedness measures between posts.

Input: Feature vectors for each post and the collection of tokenized texts.

Output: Topic cluster identifiers, post embeddings, and relatedness scores between posts.

The server computes vector representations (embeddings) for each post using a text encoder model, such as a transformer-based encoder. The server applies a clustering algorithm (for example, k-means or hierarchical clustering) to the embeddings to assign each post to a topic cluster. The server calculates similarity values, such as cosine similarity, between embeddings to quantify relatedness between posts. The server stores topic cluster identifiers and relatedness scores in association with each post record.

### Step 8

The server calculates importance scores and edits the thread content by selection, pruning, and reordering.

Input: Feature vectors, topic information, relatedness scores, and metadata such as reply counts.

Output: Edited thread information comprising a selected subset of posts, a reconstructed order of posts, and emphasis annotations.

The server computes an importance score for each post by combining multiple features, including term frequencies of salient words, density of named entities, sentiment intensity, cluster centrality, and the number of replies referencing the post. The server applies a threshold or ranking-based selection to discard posts with low importance scores. The server reconstructs the order of the remaining posts based on criteria such as chronological order within each topic cluster or ordering by narrative relevance derived from relatedness scores. The server marks high-importance sentences or phrases with emphasis metadata, such as flags or highlight tags, and stores the resulting edited thread information in a dedicated data structure.

### Step 9

The server constructs a first, analysis-dedicated prompt sentence for a generative AI model.

Input: Edited thread information including selected post texts, topic labels, importance scores, and emphasis annotations.

Output: A first prompt sentence in natural language that encodes analysis instructions and structured context for the generative AI model.

The server selects representative posts and summarizes cluster labels and importance values into a textual context. The server prepends explicit instructions describing the analytical tasks (for example, topic extraction, important post identification, episode description) and the desired output format (for example, lists or sections). The server concatenates the instructions and the context into a single prompt sentence string that guides the generative AI model to produce structured analysis rather than arbitrary narrative text.

### Step 10

The server invokes the generative AI model with the first prompt sentence to obtain structured analysis results.

Input: The analysis-dedicated prompt sentence and model configuration parameters such as maximum output length and sampling settings.

Output: Structured analysis results including topic descriptions, important post sets, and episode descriptions, represented as machine-readable text.

The server transmits the prompt sentence to the generative AI model, which is implemented as a neural network hosted locally or accessed via an external inference service. The server receives the model's output text, which is expected to follow the format requested in the prompt, and parses the output to extract topic lists, mappings from topics to post identifiers, and narrative descriptions of episodes. The server stores these structured analysis results in data structures linked to the corresponding posts and clusters.

### Step 11

The server constructs a second, generation-dedicated prompt sentence for article creation.

Input: Edited thread information and the structured analysis results obtained from the generative AI model.

Output: A second prompt sentence in natural language specifying article structure, content focus, and style constraints.

The server summarizes the main topics, important posts, and key episodes into a compact representation and embeds this representation into the body of the prompt. The server specifies that the generative AI model should generate an article with a defined structure, such as introduction, body, and conclusion, and should adopt a specified tone, such as neutral and informative. The server assembles these instructions and the summarized content into a single prompt sentence string that clearly constrains the generation task.

### Step 12

The server invokes the generative AI model with the second prompt sentence to generate article text.

Input: The generation-dedicated prompt sentence and model configuration parameters suitable for long-form text generation.

Output: Article text in natural language that summarizes the thread in a coherent, structured manner.

The server sends the second prompt sentence to the generative AI model and receives the model's output as a sequence of tokens, which the server concatenates into a character string. The server may perform basic validation on the article text, such as checking for presence of an introduction and conclusion, detecting repetitive sequences, and enforcing length limits. The server associates segments of the article text with underlying topics and important posts based on the information encoded in the prompt and in the structured analysis results.

### Step 13

The server generates display data from the article text and the edited thread information and transmits the data to the terminal.

Input: The generated article text, edited thread information, and mappings between summary segments and original posts.

Output: Display data containing markup-language content representing the article, emphasis highlights, and optional interactive links to original posts, transmitted to the terminal.

The server inserts paragraph tags, headings, and emphasis tags into the article text and embeds identifiers or links that reference important posts. The server integrates the edited thread information, such as highlighted original posts, into a format that the terminal can render alongside or beneath the article. The server sends this display data to the terminal using a response message over the communication network.

### Step 14

The terminal renders the display data for the user and supports interactive exploration of the summarized thread.

Input: Display data including formatted article text, emphasis information, and references to original posts.

Output: A visual presentation on the terminal's display, allowing the user to read the summary and optionally access related original posts.

The terminal's rendering engine interprets markup-language tags to lay out the article text, apply font styles, and highlight emphasized portions. When the user selects a highlighted phrase or a link, the terminal retrieves and displays the corresponding original post content, using the identifiers provided by the server. The terminal may also send additional requests to the server if the user requests alternative summaries or different levels of detail.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

In network-based information exchange environments such as online forums and bulletin boards, vast amounts of user-generated text data are continuously produced. Conventional content processing systems typically perform topic-based retrieval and simple keyword filtering, and may optionally apply generic summarization. However, these systems generally treat all text segments within a thread as having similar importance, and they do not effectively combine content relevance with user-specific emotional context when selecting, ordering, and transforming information. As a result, the systems often output summaries or articles that are either overloaded with low-value posts or misaligned with the user's current interest and emotional state.

Furthermore, many existing pipelines separate low-level natural language processing from higher-level generation by a generative AI model in an ad hoc manner. For example, text may be scraped and then directly summarized, or a generative AI model may be called with a generic prompt sentence. In such configurations, the generative AI model receives little or no structured guidance about which posts are objectively important, which posts are emotionally salient, and how these aspects should influence the generated article. This leads to unstable output quality, difficulty in reproducing results, and inefficiencies in computation, since large amounts of unfiltered text must be processed repeatedly.

In addition, conventional systems generally lack an integrated mechanism that (i) quantitatively analyzes emotions of both the user's input and the underlying forum content, (ii) fuses this emotion information with topic relevance to compute an importance score for each text segment, (iii) edits and structurally reorganizes the text in accordance with that score, and (iv) explicitly encodes these results into a prompt sentence for a generative AI model. Without such an integrated pipeline, it is difficult to improve the behavior of the computer system itself, for example by reducing unnecessary processing of low-value data, by stabilizing the generative model's outputs, or by dynamically optimizing the allocation of computation resources to highly relevant and emotionally aligned content.

Accordingly, there is a need for a technical solution that improves the functioning of a computer-implemented information processing system by: (1) automatically acquiring and structuring unstructured network text; (2) performing coordinated content analysis and emotion analysis; (3) calculating an evaluation value reflecting both topic relevance and emotion; (4) selecting and editing text in accordance with that evaluation value; and (5) generating a prompt sentence that conveys this structured analysis to a generative AI model. By tightly coupling these stages within a processor-implemented pipeline, the system can generate article information that is more relevant, more emotionally attuned, and more efficient to compute, thereby improving the overall computer technology for content processing and generative article production.

The specific processing by the specific processing unit 290 of the data processing device 12 in Application Example 2 is realized by the following means.

The present invention provides a server comprising a processor configured to acquire unstructured document information from an information source on a communication network by using an information acquisition unit, to extract text information in units of posts or responses from the document information and to segment the text information into linguistic units with assigned linguistic features by using a document analysis unit that applies natural language processing, to calculate emotion information indicating a type and an intensity of emotion for the text information and for text information input by a user by using an emotion analysis unit, to calculate, by using a relevance calculation unit, content relevance between the text information and an interest topic specified by the user and to calculate an evaluation value indicating an importance of the text information based on the content relevance and the emotion information, to select and edit the text information based on the evaluation value and to generate edited information by adding editing information including at least one of a change of display order and visual emphasis by using a selection and editing unit, to generate summary information by performing summarization processing on the edited information by using a summarization generation unit, to generate a prompt sentence including generation instructions based on the summary information and the emotion information by using a prompt generation unit, to input the prompt sentence to a generative AI model as a generation information processing model and to cause the generative AI model to generate article information based on the edited information and the summary information by using a generation unit, and to provide the article information and the edited information to a user terminal as display data by using a providing unit. This enables the computer-implemented server to transform unstructured network text into structured, emotion-aware, and relevance-weighted article information in a resource-efficient and reproducible manner, thereby improving the technical functioning of the content processing pipeline and stabilizing the quality and responsiveness of generative AI-based article generation.

The term “information acquisition unit” refers to a functional component implemented by hardware and/or software that causes the processor to acquire unstructured document information from an information source on a communication network, for example by sending requests and receiving responses that include text data.

The term “document analysis unit” refers to a functional component implemented by hardware and/or software that causes the processor to extract text information in units of posts or responses from acquired document information and to apply natural language processing to segment the text information into linguistic units and assign linguistic features.

The term “text information” refers to character-based data representing human language content, including at least posts, comments, replies, and other message units extracted from unstructured document information.

The term “linguistic units” refers to subdivisions of text information, such as words, tokens, phrases, clauses, or sentences, obtained through natural language processing segmentation.

The term “linguistic features” refers to attributes assigned to linguistic units, including at least part-of-speech categories, syntactic relations, named entity labels, and other grammatical or semantic annotations.

The term “emotion analysis unit” refers to a functional component implemented by hardware and/or software that causes the processor to analyze text information and user-input text information by using an emotion analysis information processing model to calculate emotion information indicating a type and an intensity of emotion.

The term “emotion information” refers to data representing an estimated emotional state associated with text information, including at least a category such as joy, sadness, or anger, and optionally a confidence value or intensity value for the category.

The term “user-input text information” refers to text data directly provided by a user, for example free-form sentences or phrases describing feelings, interests, or requests, which are processed together with other text information.

The term “emotion analysis information processing model” refers to a computational model executed by the processor that receives text as input and outputs emotion information, for example by performing classification or regression to determine emotion categories and intensities.

The term “relevance calculation unit” refers to a functional component implemented by hardware and/or software that causes the processor to calculate content relevance between text information and an interest topic specified by a user and to calculate an evaluation value indicating an importance of the text information based on the content relevance and emotion information.

The term “content relevance” refers to a quantitative measure indicating how closely text information relates to an interest topic, the measure being derived from features such as keyword overlap, semantic similarity, or topic modeling results.

The term “interest topic” refers to a subject matter or theme specified by a user, such as a keyword, phrase, or query, used as a reference to evaluate the relevance of text information.

The term “evaluation value” refers to a numerical or ordinal score that represents an importance level of text information, the score being computed based on at least content relevance and emotion information.

The term “selection and editing unit” refers to a functional component implemented by hardware and/or software that causes the processor to select and edit text information based on an evaluation value and to generate edited information by adding editing information including at least one of a change of display order and visual emphasis.

The term “edited information” refers to text information that has been filtered, reordered, or modified according to an evaluation value and that has been augmented with editing information such as display order, grouping, or highlighting attributes.

The term “editing information” refers to control data associated with text information that indicates how the text information is to be presented or arranged, including at least display order information and visual emphasis information.

The term “display order” refers to an order or sequence in which text information is to be presented to a user, such as a ranking from higher importance to lower importance, as determined by the processor.

The term “visual emphasis” refers to a display attribute applied to text information, such as bolding, coloring, enlargement, or other styling, used to visually distinguish important or emotionally salient portions of the text.

The term “summarization generation unit” refers to a functional component implemented by hardware and/or software that causes the processor to perform summarization processing on edited information to generate summary information.

The term “summarization processing” refers to a computational procedure that transforms longer text information into shorter text information by selecting and compressing content while preserving principal points or key ideas.

The term “summary information” refers to text data representing a condensed version of edited information, in which important content elements are preserved and less important content elements are reduced or omitted.

The term “prompt generation unit” refers to a functional component implemented by hardware and/or software that causes the processor to generate a prompt sentence including generation instructions based on summary information and emotion information.

The term “prompt sentence” refers to a text instruction sequence supplied as input to a generative AI model, the text instruction sequence describing desired content, style, or constraints for generation, and including at least information derived from summary information and emotion information.

The term “generation unit” refers to a functional component implemented by hardware and/or software that causes the processor to input a prompt sentence to a generative AI model as a generation information processing model and to cause the generative AI model to generate article information based on edited information and summary information.

The term “generative AI model” refers to a machine-implemented model that generates natural language text from a prompt sentence, the model being trained on text data and configured to produce article information consistent with instructions contained in the prompt sentence.

The term “generation information processing model” refers to a type of information processing model implemented by software and/or hardware that, when supplied with a prompt sentence, outputs generated text, and that includes at least a generative AI model.

The term “article information” refers to generated text content that presents information in an article-like form, including at least a sequence of sentences arranged as a summary article, explanatory article, or customized article for a user.

The term “providing unit” refers to a functional component implemented by hardware and/or software that causes the processor to provide article information and edited information to a user terminal as display data through a communication interface.

The term “display data” refers to data formatted so that a user terminal can present article information and edited information on a display device, including at least text content and optional layout or styling information.

The term “user terminal” refers to an electronic apparatus operated by a user, such as a portable terminal, a general-purpose computer, or another communication terminal, which is configured to receive display data from the server and present the data on a display.

In one embodiment, the invention is implemented as a server-side information processing system that cooperates with one or more user terminals via a communication network. The server includes at least one processor, a memory storing programs and data structures, a non-volatile storage device, and a network interface. The terminal includes a processor, a memory, a display device, and an input interface such as a touch panel or keyboard, and is connected to the server through the network.

The server executes an operating system and application software implemented, for example, in a high-level programming language. The server stores in the memory a set of software modules corresponding to the information acquisition unit, the document analysis unit, the emotion analysis unit, the relevance calculation unit, the selection and editing unit, the summarization generation unit, the prompt generation unit, the generation unit, and the providing unit as defined in the claims. Each unit is realized by executable instructions that cause the processor to perform specific data transformations on text data.

The server uses a communication stack, such as a TCP/IP stack and an HTTPS protocol implementation, to communicate with remote information sources and with the terminal. The server acquires unstructured document information from information exchange environments such as forums or bulletin boards by issuing HTTP requests and receiving HTML or other text-based formats in response. The server may employ a general-purpose HTML parsing library such as a document object model parser to parse tags and attributes, but the system is not limited to such a library.

The server, in the document analysis unit, converts raw HTML or markup data into a structured internal representation. The server constructs, in memory, a hierarchical or graph-based data structure containing thread identifiers, post identifiers, parent-child reply relationships, and text strings. For example, the server may store a list of thread records, each thread record including an array of post records. Each post record includes at least a unique identifier, a text field, a timestamp, and references to other posts. By converting unstructured markup into such structured records, the server enables subsequent modules to operate efficiently on arrays and hash maps rather than on free-form markup, thereby reducing parsing overhead in later stages.

The server further performs natural language processing in the document analysis unit. The server applies a tokenizer and part-of-speech tagger to decompose each post text into tokens, and annotates each token with features such as part-of-speech category, lemma, and syntactic dependency relationship. The server may further extract named entities and domain-specific terms by applying a sequence labeling model. These linguistic features are stored as attribute lists associated with each post. Because the server precomputes these features, later computations in the relevance calculation unit can operate on compact numerical representations rather than reprocessing raw text, which improves processing speed and reduces memory bandwidth usage.

The server, in the emotion analysis unit, executes an emotion analysis information processing model to calculate emotion information. In one embodiment, the server implements the emotion analysis model as a neural network having a transformer architecture. The neural network includes a plurality of self-attention layers, each self-attention layer including multi-head attention mechanisms, feed-forward sublayers, and normalization sublayers. The server stores learned weight matrices and bias vectors in the memory, and applies the model to sequences of token embeddings derived from the text information.

The server pre-trains or fine-tunes the neural network using supervised learning. The server uses a corpus of text examples labeled with emotion categories such as joy, sadness, anger, fear, or neutral, and optionally with real-valued intensity scores. The server defines a loss function such as cross-entropy loss between predicted emotion category distributions and ground-truth labels, and may add regularization terms to prevent overfitting. During training, the server performs forward propagation to compute predicted probabilities, calculates the loss, and performs backpropagation to compute gradients with respect to model parameters. The server updates the weights using an optimization algorithm such as stochastic gradient descent or an adaptive gradient method. The server may apply data augmentation techniques such as synonym replacement or back-translation to increase training data diversity. As a result of such training, the emotion analysis model achieves improved accuracy compared to rule-based emotion detection or simple sentiment lexicons, and the server can classify emotions with high confidence in real time.

The server applies the trained emotion analysis model not only to the posts and replies extracted from the forum but also to user-input text information entered at the terminal. The server converts each text into a sequence of token indices, maps the indices to embedding vectors, and passes the sequence through the transformer network. The server obtains a fixed-dimensional representation at a classification token position or by pooling over token representations, and applies a final linear layer to output a probability distribution over emotion categories. By computing a vector of category probabilities and an associated intensity score, the server generates structured emotion information for each post and for user input.

The server, in the relevance calculation unit, computes a content relevance measure between each post and an interest topic specified by the user. The user operates the terminal to enter one or more keywords, phrases, or a natural language description of a topic. The terminal packages this topic information and transmits it to the server. The server converts the topic expression into a vector representation using a sentence embedding model or a topic embedding derived from the same or a different neural network. For each post, the server computes a content vector by averaging or pooling token embeddings or by extracting a designated representation from a network. The server then calculates a similarity measure, such as cosine similarity, between the topic vector and each content vector. The server stores the resulting similarity scores as content relevance values.

The server calculates an evaluation value for each post by combining the content relevance and the emotion information. In one embodiment, the server defines the evaluation value as a weighted sum of normalized content relevance and normalized emotion alignment. The server may compute emotion alignment as a function of the similarity between the emotion distribution of the user input and the emotion distribution of the post, for example by computing the inner product of probability vectors or by calculating a distance measure. The server may further incorporate additional features, such as post length, recency, or reply count, into the evaluation value. By structuring the evaluation as a numerical computation in a well-defined feature space, the server enables efficient sorting and filtering using standard numerical operations, and the server can adjust weight parameters dynamically to optimize system performance.

The server, in the selection and editing unit, selects posts based on evaluation values. The server, for example, discards posts whose evaluation value falls below a threshold, and sorts the remaining posts in descending order of evaluation value. The server may group posts into segments according to similar emotion categories or similar content topics. The server generates edited information that includes the selected posts, their order, and editing information such as display priority and visual emphasis flags. This editing information is represented as structured metadata fields attached to each post record, such as a priority rank, a highlight flag, and a group identifier.

The server's selection and editing logic is not limited to simple rank-ordering. In one embodiment, the server applies a non-standard rule set in which posts are rearranged to form a more coherent narrative based on emotion shifts and topic transitions. For example, the server may first list posts expressing similar negative emotions as the user, followed by posts that offer advice or positive perspectives, thereby constructing an emotionally considerate information flow that would be difficult to manually design at scale. This rule set uses emotion trajectories and similarity graphs between posts to reorganize content in a non-linear manner, which is distinct from ordinary chronological or purely relevance-based sorting.

The server, in the summarization generation unit, performs summarization processing on the edited information. The server may implement a separate summarization neural network, which can also be a transformer-based encoder-decoder architecture trained to generate shorter sequences from longer input sequences. The server constructs a summarization input by concatenating the top-ranked posts or by encoding them as a sequence with segment delimiters. The server applies the encoder to obtain hidden representations and applies the decoder with attention to generate summary sentences. The server may train the summarization model using pairs of long and short texts, with a sequence-to-sequence loss function such as token-level cross-entropy. During inference, the server uses beam search or sampling methods with constraints to generate coherent summaries. The server stores the resulting summary information as a textual field associated with a thread or group of posts. The server, in the prompt generation unit, generates a prompt sentence based on the summary information and the emotion information. The server constructs the prompt sentence by embedding key phrases, summary sentences, explicit generation instructions, and indications of user emotion into a single natural language instruction. The server may use a template that includes placeholders for topic, user emotion, and bullet-point summary. For example, the server may generate prompt sentences such as:

“Please summarize the threads from the anonymous bulletin board about the latest technology. Extract the most important points and present them in a concise article.” “The user is feeling that ‘today was the worst day’. Based on the following posts from the anonymous bulletin board, generate a summary article that reflects the user's emotion and highlights replies that share similar feelings and provide empathy.”

“Using the following scraped thread data and the detected user emotion ‘sadness’, generate a customized summary article that prioritizes emotionally similar posts and clearly explains the main flow of the discussion.”

By encoding the results of structured analysis, such as evaluation values and emotion categories, into the prompt, the server constrains the generative AI model in a way that reduces variability and focusing the generation on system-selected content. This differs from generic prompt usage where raw text is simply appended without pre-selection.

The server, in the generation unit, inputs the prompt sentence to a generative AI model. The generative AI model is implemented as a large-scale neural network, for example a transformer-based language model trained on a wide corpus of text. The server supplies the prompt as a sequence of token identifiers, and the model generates an output sequence by repeatedly applying transformer layers and computing probability distributions over tokens at each position. The server may configure generation parameters such as maximum sequence length, sampling temperature, and top-k or top-p thresholds. Because the prompt sentence encodes the selection and editing results, the generative model can focus on reconstructing a coherent narrative or article from a much smaller, pre-filtered set of posts, which leads to reductions in computation time and memory usage and improves output relevance.

The server executes the generation model on hardware that may include graphical processing units or specialized accelerators to achieve high throughput. The server may host several models with different sizes and select an appropriate model depending on available resources and requested output quality. The server may cache intermediate representations for frequently requested topics, thereby reducing repeated computation.

The server, in the providing unit, packages the generated article information and the edited information into display data, which may be structured as a markup document, a structured message, or another representation suitable for the terminal. The server includes metadata indicating which sentences or posts should be visually emphasized, and which segments correspond to specific emotions or topics. The server transmits the display data to the terminal through the network.

The terminal receives the display data, parses it, and renders it on the display. The terminal may use a browser engine or a native rendering engine to apply formatting such as font size, color, or layout. The terminal visually emphasizes posts or sentences marked as important, and may provide interaction controls such as buttons for expanding details or requesting alternative summaries. The user views the rendered article and, if desired, enters further input, such as a new topic, emotion description, or refinement request.

The described configuration produces several technical effects beyond mere automation of human reading and summarization. Because the server converts unstructured network text into a structured representation with explicit evaluation values and emotion labels, the server can avoid transmitting and processing low-value posts, thereby reducing network traffic and computational load. The combination of content relevance and emotion alignment in a single evaluation value leads to more focused selections, which improves the precision of the generated article and reduces noise.

Moreover, by separating the roles of analysis modules and the generative AI model, and by encoding analysis results into the prompt sentence, the system improves the determinism and reproducibility of generative outputs. The generative AI model operates on curated, ranked content instead of the full raw corpus, which reduces the effective input space and mitigates inconsistent behavior. This architecture improves the technical functioning of the text generation pipeline, including faster generation due to shorter prompts, more stable outputs with fewer hallucinations, and reduced energy consumption in the computation hardware.

The server's use of transformer models for both emotion analysis and summarization is combined with specific data structures and weighting schemes that reflect the evaluation value. The system applies non-conventional processing rules that reorganize posts based on emotion trajectories and similarity graphs, which is different from traditional chronological sorting. This reorganization provides a machine-specific advantage: the server can compute stronger locality in the data, grouping related posts together and enabling cache-friendly access patterns and batched processing in the neural network, which enhances throughput.

In an alternative embodiment, the server may employ different neural network architectures, such as recurrent networks or convolutional networks, for certain modules, or may integrate rule-based components that use hand-crafted patterns to identify specific domain terms before neural processing. In another embodiment, the server may adjust weight parameters of the evaluation value in real time according to feedback from user behavior, such as click-through rates or reading times, and may retrain models periodically with updated data. The core structure of acquiring unstructured text, structurally analyzing it, combining content and emotion to compute evaluation values, editing and summarizing based on those values, constructing a prompt sentence with explicit generation instructions, and using a generative AI model to produce article information remains common across embodiments.

The system thus improves computer technology by introducing a coordinated pipeline of text acquisition, structured analysis, emotion-aware evaluation, rule-based editing, and generative article production that collectively optimize resource usage and output quality. The server reduces redundant computation on unimportant data, organizes memory and processing around structured evaluation values, and controls the generative AI model through a carefully constructed prompt sentence. These aspects result in measurable improvements such as shorter processing times, reduced bandwidth, higher accuracy in reflecting user interests and emotions, and lower error rates in generated summaries, thereby demonstrating a technical contribution rather than a mere automation of a mental process.

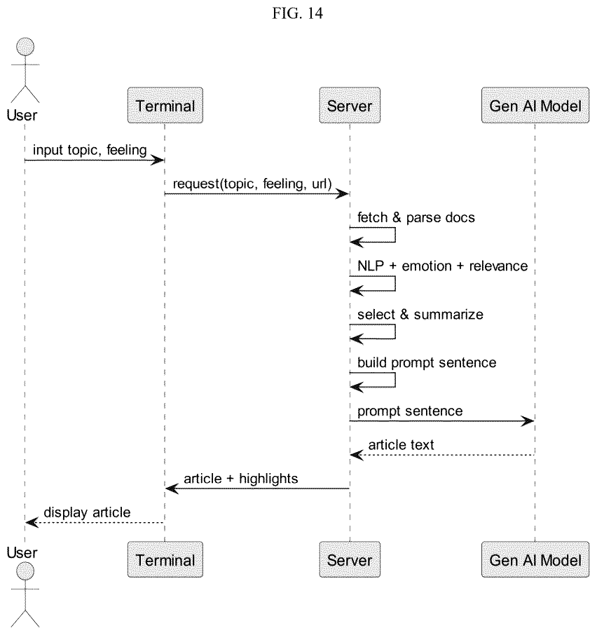

The following describes the processing flow using FIG. 14.

### Step 1

The user operates the terminal to input a request. The user selects or inputs at least one interest topic, such as a keyword phrase, and may also input free-form text describing a current feeling or situation. The terminal receives this input as character strings and optionally a target URL of an information source. The terminal converts these values into structured request data including fields such as topic text, user-emotion text, and optional URL, and outputs this structured request data to the server over a network connection.

### Step 2

The server receives the structured request data from the terminal as input. The server parses the request to extract the topic text, the user-emotion text, and any provided URL. Based on the topic text and URL, the server constructs one or more target resource identifiers for information sources, for example by appending query parameters to a base address or by selecting predefined endpoints associated with the topic. The server outputs a list of target resource identifiers to an internal acquisition module as a data structure.

### Step 3

The server uses the list of target resource identifiers as input to acquire unstructured document information from network-connected information sources. The server sends network requests through a communication interface and receives document payloads such as HTML pages or textual data streams. The server interprets the responses to extract the document bodies and aggregates them into an internal buffer. The server outputs this aggregated unstructured document information as a sequence of documents ready for parsing.

### Step 4

The server takes the unstructured document information as input and executes document analysis. The server parses markup structures, identifies thread boundaries, and detects individual posts or responses. The server strips tags and control sequences, normalizes character encoding, and segments the content into post units. For each post unit, the server extracts attributes such as text, timestamp, and thread identifier and stores them into a structured data representation, for example a list of thread records each containing a list of post records. The server outputs this structured text information as a collection of post objects with associated metadata.

### Step 5

The server uses the structured text information as input to perform linguistic preprocessing. The server applies tokenization, sentence segmentation, and part-of-speech tagging to each post text. The server further computes syntactic relationships and, where applicable, identifies named entities and domain-specific terms. These operations transform raw character sequences into sequences of linguistic units with associated features. The server stores the resulting annotations as feature lists attached to each post object and outputs an enriched text dataset that includes both original texts and linguistic features.

### Step 6

The server takes the enriched text dataset and the user-emotion text as inputs to the emotion analysis unit. The server converts each text into token indices, maps them to numerical embeddings, and feeds the embeddings into an emotion analysis model. The model computes internal representations and outputs probability distributions over emotion categories and associated intensity scores. The server interprets these outputs as emotion information, consisting of at least one emotion type and a numerical value per text. The server attaches the emotion information to each post and to the user-emotion text and outputs an emotion-annotated dataset.

### Step 7

The server uses the emotion-annotated dataset and the topic text as inputs to the relevance calculation unit. The server generates a topic representation by embedding the topic text into a numerical vector space. For each post, the server derives a content representation from the linguistic features or from a dedicated embedding model. The server computes similarity measures between the topic representation and each content representation, and generates content relevance scores. The server further computes emotion alignment scores by comparing the user's emotion information with the post's emotion information. The server then combines the content relevance scores and emotion alignment scores, for example by weighted summation, to calculate an evaluation value for each post. The server outputs a list of posts annotated with evaluation values.

### Step 8

The server takes the list of posts with evaluation values as input to the selection and editing unit. The server filters out posts whose evaluation values do not satisfy a predetermined criterion, such as being below a threshold or outside a ranking range. The server sorts the remaining posts based on their evaluation values and optionally groups them into clusters according to emotion type or topic similarity. The server generates editing information including display order indices and visual emphasis flags for each selected post. The server attaches this editing information to the post records and outputs edited information that consists of the selected, ordered, and annotated posts.

### Step 9

The server uses the edited information as input to the summarization generation unit. The server constructs a summarization input text by concatenating or otherwise organizing the selected posts according to their display order and group structure. The server applies a summarization algorithm that computes significance scores, identifies representative sentences, and composes condensed sentences. The server thereby transforms a larger volume of edited text into a shorter representation that preserves main ideas and emotional context. The server outputs summary information in the form of one or more summary paragraphs or bullet-style statements.

### Step 10

The server takes the summary information, the user's emotion information, and the edited information as inputs to the prompt generation unit. The server assembles a prompt sentence by embedding the summary content, explicit mention of the user's emotional state, and instructions for desired output style into a single or multi-sentence natural language instruction. The server may include markers or delimiters identifying key points and emotional cues. This assembly process converts structured data into a linear instruction sequence optimized for input to a generative AI model. The server outputs the constructed prompt sentence as a text string.

### Step 11

The server uses the prompt sentence as input to the generation unit. The server supplies the prompt sentence to a generative AI model configured to generate natural language output. The generative AI model processes the prompt by applying a sequence of transformations over model layers and produces a continuation sequence of tokens. The server decodes the generated tokens into characters and sentences, forming article information that integrates and elaborates on the summarized content and emotional guidance. The server optionally removes incomplete sequences or adjusts formatting and outputs a finalized article text.

### Step 12

The server takes the finalized article text and the edited information as inputs to the providing unit. The server combines the article text with metadata about highlighted posts, groupings, and emphasis markers to form display data. The server organizes this data into a format suitable for rendering at the terminal, such as structured fields indicating main article sections and linked original posts. The server transmits the display data through the network interface and outputs it as a response message addressed to the terminal.

### Step 13

The terminal receives the display data as input from the server. The terminal parses the data to extract the article text, the positions of highlighted portions, and any links back to original threads or posts. The terminal composes a visual layout by placing the article text in a main viewing region and applying visual emphasis, such as font changes or color, to elements marked for highlighting. The terminal renders this layout on the display device and outputs the visual representation to the user.

### Step 14

The user observes the displayed article and edited post information on the terminal. Based on the content and perceived relevance, the user may input additional commands, such as requests for more detailed information, alternative emotional focus, or different topics. The terminal receives these additional inputs, updates the structured request data accordingly, and outputs a new request to the server, thereby enabling iterative refinement of the generated content.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

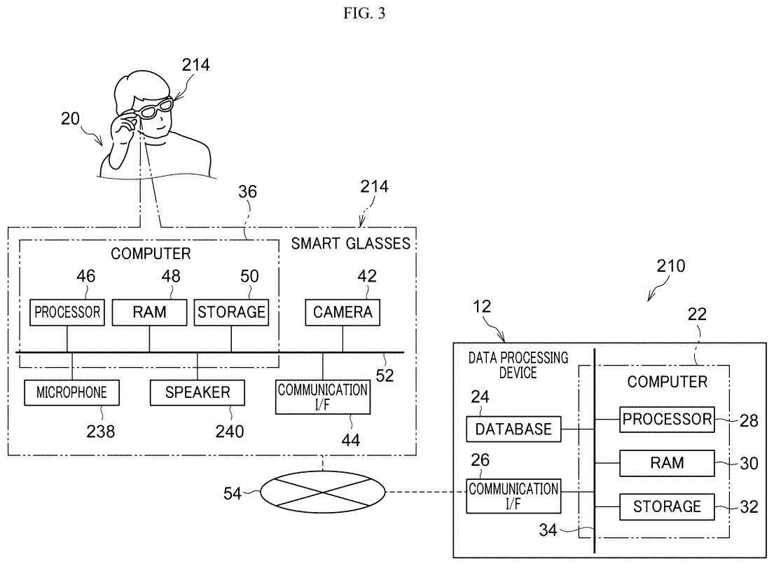

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

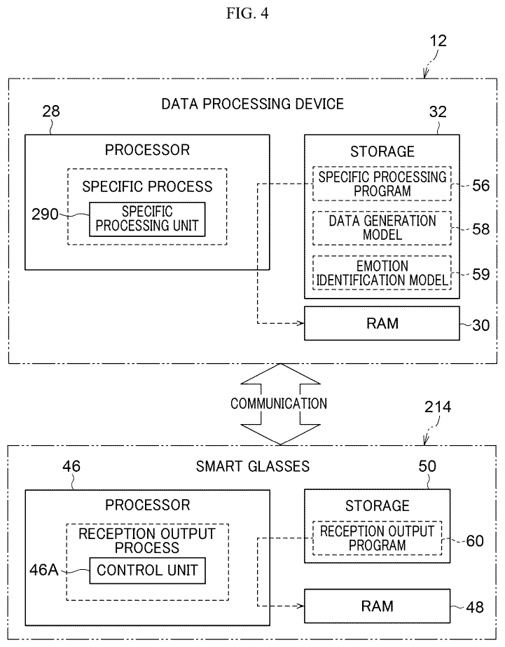

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

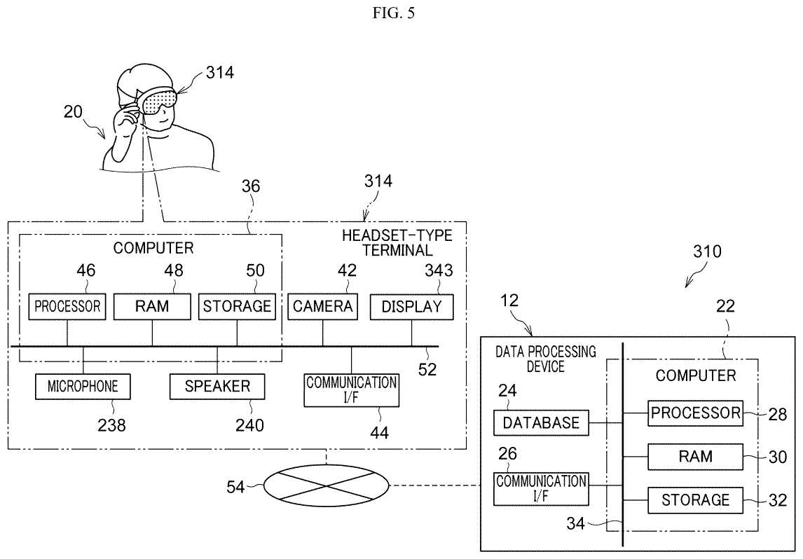

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

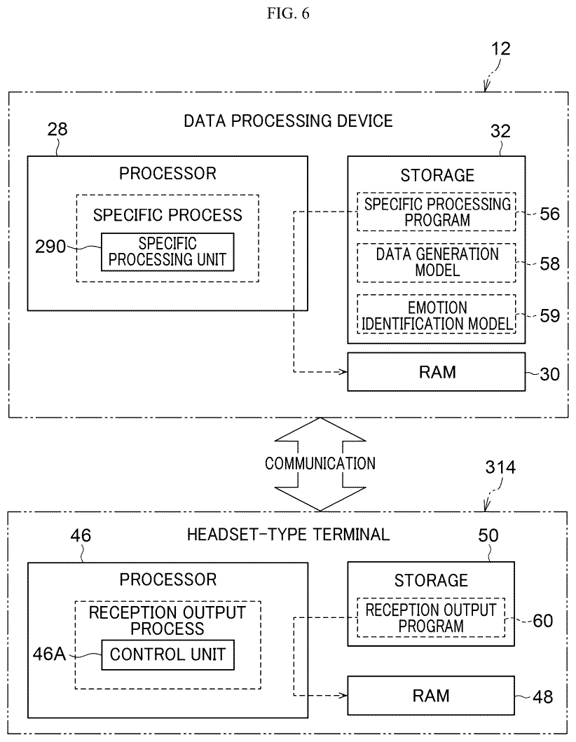

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

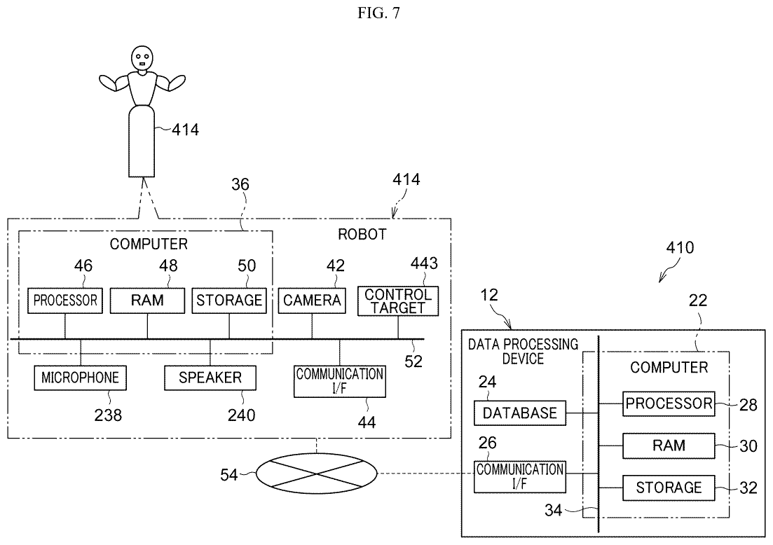

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

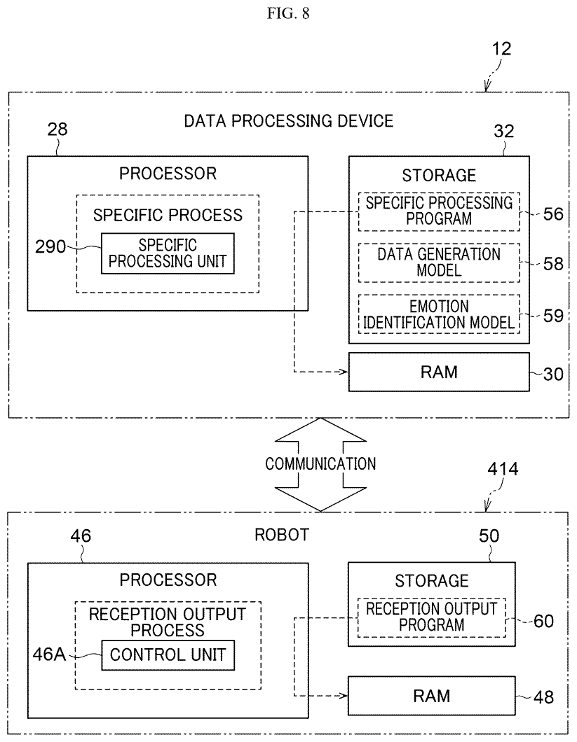

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

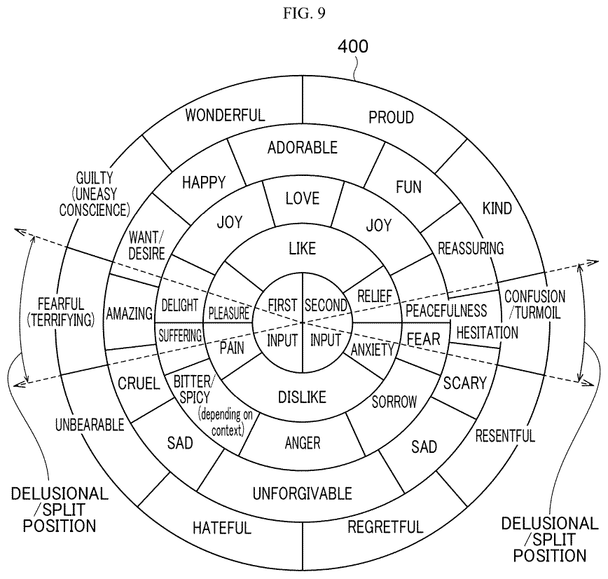

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

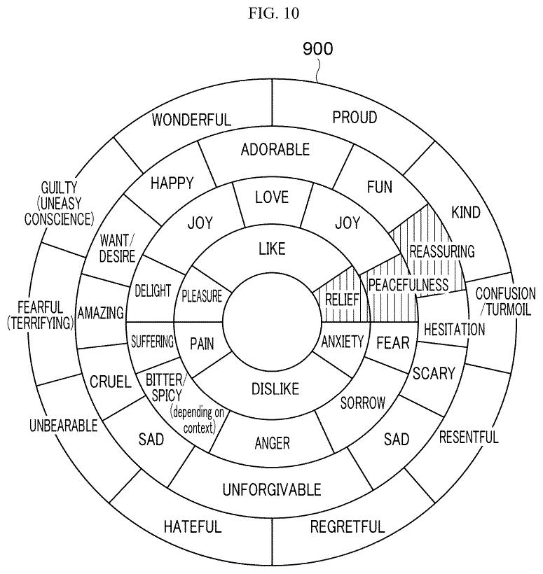

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
acquire, by an information acquisition unit, information having a document structure from a posting source on a communication network as an information source,
analyze, by a structure analysis unit, the document structure included in the acquired information to extract text data in units of posts and associated metadata,
perform, by a natural language processing unit using a statistical language model or a machine learning model, natural language processing on the extracted text data to calculate, for each post, an importance index, emotion information, and topic classification information,
edit, by an editing unit, the extracted text data based on the calculated importance index and the topic classification information by selecting posts, performing reordering and grouping, and associating text portions determined to be important with mark information for emphasis so as to generate structured edited information,
generate, by a prompt generation unit, a prompt sentence for a generative AI model based on the edited information and analysis information including a result of the natural language processing,
generate, by an article generation unit, a summary article or an explanatory article by inputting the prompt sentence to the generative AI model and create article data in which the mark information for emphasis in the edited information is reflected, and
convert, by an output unit, the created article data into a standardized markup format or an electronic document format and provide the converted article data in a form accessible from a user terminal.

### Supplementary 2

The system according to supplementary 1,
wherein the processor is configured to perform the natural language processing by inputting, to the generative AI model, a prompt sentence including an analysis instruction, and by obtaining, from the generative AI model, information regarding important phrases, topic outlines, and humor elements, and using the obtained information as the analysis information.

### Supplementary 3

The system according to supplementary 1,
wherein the processor is configured to convert the article data by automatically determining chapter structure and quotation placement in the article based on the importance index and the grouping result in the edited information, and by presenting the summary article to a user.

### Application Example 1

### Supplementary 1

A system comprising a processor,
wherein the processor is configured to
receive identification information of an anonymous posting information source and acquire, via a communication unit, a plurality of posting data from the anonymous posting information source, convert the acquired plurality of posting data into structured data and, by using an analysis unit employing natural language processing technology, calculate importance information and topic information for each posting data and generate analysis result data including conversation flow information and interest-evoking information,
perform an editing process including a pruning process for deleting posting data having low importance, an order control process for reconstructing a display order of the posting data, and an emphasis-adding process for causing predetermined phrases to be displayed in an emphasized manner, based on the analysis result data, and generate edited thread information,
generate a prompt sentence for causing a summary article of the edited thread information to be generated, based on context data including the edited thread information and instruction information including article generation conditions and concepts to be emphasized,
input the prompt sentence and the edited thread information to a generative artificial intelligence model and cause the generative artificial intelligence model to generate the summary article reflecting contents of the edited thread information, and
transmit the generated summary article to a terminal device and control output such that the terminal device displays the summary article in a viewable format.

### Supplementary 2

The system according to supplementary 1,
wherein the processor is configured to use, as the natural language processing technology, a deep learning model to calculate an embedding representation of each posting data, generate cluster information by topic and emotion information based on the embedding representation, and output the analysis result data used for the pruning process and the order control process.

### Supplementary 3

The system according to supplementary 1,
wherein the processor is configured to generate the prompt sentence by identifying, within the edited thread information, at least descriptions relating to a generative artificial intelligence model and descriptions relating to a prompt sentence as the concepts to be emphasized, and by incorporating, into the prompt sentence, instruction information including a condition that these concepts to be emphasized are to be described in an emphasized manner in the summary article.

### Example 2

### Supplementary 1

A system comprising a processor,
wherein the processor is configured to
receive identification information of an information source from a user terminal via a communication network and access the information source based on the identification information to acquire thread information in a standardized data format by executing an acquisition process using a data collection unit,
parse a structure of markup-language data included in the acquired thread information to extract text data and metadata for each post, and perform preprocessing including string normalization and sentence segmentation to generate structured data from the thread information,
execute an analysis process on the preprocessed text data by using a language-processing library and a natural language processing technique to perform morphological analysis, part-of-speech tagging, named entity extraction, sentiment determination, and term frequency calculation, and to generate feature information for each post and topic information for an entire thread,
execute an editing process based on the feature information and the topic information to calculate a relatedness between posts, determine an importance score and a topic cluster for each post, select or prune the posts according to the importance score, reconstruct an order of the posts in at least one of a chronological order and a topic-based order according to the relatedness, and generate edited thread information to which emphasis information indicating an important portion is added,
generate a first prompt sentence that defines an instruction, a data structure, and an output format for a generative language model to generate a prompt sentence including at least one of an analysis instruction and a summarization instruction for the generative language model, the first prompt sentence being generated using post text, the topic information, the importance information, and the emphasis information included in the edited thread information as input information, and input the first prompt sentence to the generative language model to acquire a structured analysis result regarding at least one of a main topic, an important post, and an episode in the thread,
generate a second prompt sentence based on the structured analysis result and the edited thread information, the second prompt sentence defining an article structure, a writing style, and a summarization policy and including an article generation instruction for generating an article including an introduction part, a body part, and a conclusion part, and input the second prompt sentence to the generative language model to cause the generative language model to execute an article generation process to generate article text summarizing an entire thread, and
execute an output process to convert the article text and the edited thread information into display data and transmit the display data to the user terminal.

### Supplementary 2

The system according to supplementary 1,
wherein the processor is configured to
generate the first prompt sentence as an analysis-dedicated prompt sentence that is configured to define a role of the generative language model, an output format, and return data items for performing at least one of topic extraction, important post extraction, and episode extraction based on at least part of the thread information or a summary thereof, and to cause the generative language model, in response to the analysis-dedicated prompt sentence, to return structured data including at least one of a topic list, an important post set, and an episode description, and to execute the editing process using the structured data to perform at least one of importance score calculation, cluster classification, and emphasis assignment for the posts.

### Supplementary 3

The system according to supplementary 1,
wherein the processor is configured to
generate the second prompt sentence as a generation-dedicated prompt sentence that is configured to define, together with input data including the edited thread information and the structured analysis result, at least one of a paragraph structure of an article, a set of topics to be explained, an order of presentation of important episodes, and a style condition, and to cause the generative language model, in response to the generation-dedicated prompt sentence, to automatically generate a summary article that enables a reader to understand content of the thread without referring to an original thread, and to provide, in the output process, the summary article to a user in association with important post information serving as a basis for the summary article.

### Application Example 2

### Supplementary 1

A system comprising a processor,
wherein the processor is configured to
acquire unstructured document information from an information source on a communication network by using an information acquisition unit,
extract text information in units of posts or responses from the document information and segment the text information into linguistic units by using a document analysis unit that applies natural language processing to assign linguistic features,
calculate emotion information indicating a type and an intensity of emotion for the text information and for text information input by a user by using an emotion analysis unit,
calculate, by using a relevance calculation unit, content relevance between the text information and an interest topic specified by the user, and calculate an evaluation value indicating an importance of the text information based on the content relevance and the emotion information,
select and edit the text information based on the evaluation value, and generate edited information by adding editing information including at least one of a change of display order and visual emphasis by using a selection and editing unit,
generate summary information by performing summarization processing on the edited information by using a summarization generation unit,
generate a prompt sentence including generation instructions based on the summary information and the emotion information by using a prompt generation unit,
input the prompt sentence to a generative AI model as a generation information processing model and cause the generative AI model to generate article information based on the edited information and the summary information by using a generation unit, and
provide the article information and the edited information to a user terminal as display data by using a providing unit.

### Supplementary 2

The system according to supplementary 1,
wherein the processor is configured to
analyze the text information and the text information input by the user by using an emotion analysis information processing model in the emotion analysis unit, and use the emotion information both for calculation of the evaluation value by the relevance calculation unit and for generation of the prompt sentence by the prompt generation unit.

### Supplementary 3

The system according to supplementary 1,
wherein the processor is configured to
automatically generate the article information by inputting the prompt sentence to the generative AI model in the generation unit, and cause the providing unit to provide the article information to the user as at least one of a summary article and a customized article.

What is claimed is:

1. A system comprising:
circuitry configured to
receive, via a packet-switched network, a resource identifier from a terminal device;
acquire, based on the resource identifier, document data having a hierarchical markup structure from a data source accessible via the packet-switched network;
parse the hierarchical markup structure of the document data to extract a plurality of text data segments and associated metadata into a structured data representation;
execute a natural language processing pipeline on the plurality of text data segments to compute, for each text data segment, a feature vector comprising at least an importance score, an affective state classification, and a topic cluster identifier;
generate edited data by selecting a subset of the plurality of text data segments based on the importance score, reconstructing a sequence order of the subset, and associating emphasis metadata with designated portions of the subset;
construct a structured input sequence for a generative neural network model based on the edited data and the feature vector, the structured input sequence comprising natural language instruction tokens specifying an output structure and content constraints;
input the structured input sequence to the generative neural network model and obtain inference output data comprising generated text organized according to the output structure; and
transmit, via the packet-switched network, display data derived from the inference output data and the edited data to the terminal device for rendering on a display of the terminal device.

2. The system according to claim 1, wherein the natural language processing pipeline comprises a tokenization module that segments each text data segment into a sequence of subword tokens, and a transformer-based encoder model that computes contextualized embedding vectors from the sequence of subword tokens.

3. The system according to claim 2, wherein the circuitry is further configured to apply a classification layer to the contextualized embedding vectors to compute the importance score as a scalar value, and to apply a clustering algorithm to the contextualized embedding vectors across the plurality of text data segments to assign the topic cluster identifier to each text data segment.

4. The system according to claim 3, wherein the clustering algorithm comprises a k-means algorithm or a hierarchical clustering algorithm applied to aggregated embedding vectors, and wherein the circuitry is further configured to compute a relatedness measure between text data segments based on a distance metric in an embedding space.

5. The system according to claim 4, wherein the circuitry is further configured to extract, from each text data segment, named entity labels and part-of-speech annotations, and to compute term frequency values for tokens and phrases within each text data segment and across the plurality of text data segments.

6. The system according to claim 1, wherein generating the edited data comprises discarding text data segments whose importance score falls below a predetermined threshold, and sorting the remaining text data segments according to at least one of a chronological order within each topic cluster and a descending importance score order.

7. The system according to claim 6, wherein the circuitry is further configured to group the remaining text data segments into sections based on the topic cluster identifier, and to insert section boundary markers between groups in the edited data.

8. The system according to claim 7, wherein associating emphasis metadata comprises identifying key phrase spans within the remaining text data segments based on at least one of token-level attention weight values and a phrase scoring algorithm, and tagging the identified key phrase spans with emphasis indicator values.

9. The system according to claim 8, wherein the emphasis indicator values comprise at least one of a highlight flag and a visual differentiation tag, and wherein the display data transmitted to the terminal device includes rendering instructions corresponding to the emphasis indicator values.

10. The system according to claim 1, wherein the circuitry is further configured to construct a first structured input sequence defining an analysis task for the generative neural network model, input the first structured input sequence to the generative neural network model, and obtain structured analysis result data comprising at least one of a topic list, an important segment set, and a descriptive summary of identified episodes.

11. The system according to claim 10, wherein the circuitry is further configured to construct a second structured input sequence based on the structured analysis result data and the edited data, the second structured input sequence defining an article generation task specifying an article structure comprising an introduction section, a body section, and a conclusion section.

12. The system according to claim 11, wherein the inference output data obtained in response to the second structured input sequence comprises article text organized into the introduction section, the body section, and the conclusion section, and wherein the circuitry is further configured to associate segments of the article text with corresponding text data segment identifiers from the edited data.

13. The system according to claim 1, wherein the circuitry is further configured to receive, via the packet-switched network, an input character sequence from the terminal device, to compute an affective state indicator for the input character sequence using the natural language processing pipeline, and to calculate an evaluation value for each text data segment based on a combination of the importance score and an alignment measure between the affective state indicator and the affective state classification of the text data segment.

14. The system according to claim 13, wherein the circuitry is further configured to incorporate the affective state indicator into the structured input sequence such that the generative neural network model generates the inference output data reflecting the affective state indicator in at least one of content selection and narrative tone.

15. The system according to claim 1, wherein the generative neural network model comprises a transformer-based architecture including an embedding layer, a plurality of self-attention layers, a plurality of feed-forward layers, and an output projection layer, and wherein the circuitry is further configured to set at least a sampling temperature parameter and a maximum output token count parameter prior to inputting the structured input sequence.

16. The system according to claim 1, wherein the circuitry is further configured to convert the inference output data into at least one of a standardized markup document and an electronic page description document, and to store the converted document in a storage device accessible via the packet-switched network.

17. The system according to claim 1, wherein the circuitry is further configured to receive, via the packet-switched network, feedback data from the terminal device, and to update at least one of the predetermined threshold used in selecting the subset or weight parameters used in computing the importance score based on the feedback data.

18. A system comprising:
circuitry configured to
receive, via a packet-switched network, a resource identifier and an input character sequence from a terminal device;
acquire document data from a data source based on the resource identifier and parse the document data to extract a plurality of text data segments into a structured data representation;
execute a natural language processing pipeline on the plurality of text data segments to compute, for each text data segment, an importance score, an affective state classification, and a topic cluster identifier;
compute an affective state indicator for the input character sequence and calculate an evaluation value for each text data segment based on a combination of the importance score and an alignment measure between the affective state indicator and the affective state classification;
generate edited data by selecting text data segments based on the evaluation value, reconstructing a sequence order, grouping the selected text data segments into topic-based sections, and associating emphasis metadata with designated portions;
construct a first structured input sequence for a generative neural network model to obtain structured analysis result data, and construct a second structured input sequence based on the structured analysis result data and the edited data to obtain inference output data comprising article text; and
transmit, via the packet-switched network, display data derived from the inference output data and the edited data to the terminal device for rendering on a display of the terminal device.

19. The system according to claim 18, wherein the circuitry is further configured to parse the article text to identify section delimiter tokens and quotation reference tokens, and to associate segments of the article text with corresponding text data segment identifiers from the edited data to enable interactive navigation between the article text and source text data segments on the terminal device.

20. A method performed by a system comprising circuitry, the method comprising:
receiving, via a packet-switched network, a resource identifier from a terminal device;
acquiring, based on the resource identifier, document data having a hierarchical markup structure from a data source accessible via the packet-switched network;
parsing the hierarchical markup structure of the document data to extract a plurality of text data segments and associated metadata into a structured data representation;
executing a natural language processing pipeline on the plurality of text data segments to compute, for each text data segment, a feature vector comprising at least an importance score, an affective state classification, and a topic cluster identifier;
generating edited data by selecting a subset of the plurality of text data segments based on the importance score, reconstructing a sequence order of the subset, and associating emphasis metadata with designated portions of the subset;
constructing a structured input sequence for a generative neural network model based on the edited data and the feature vector, the structured input sequence comprising natural language instruction tokens specifying an output structure and content constraints;
inputting the structured input sequence to the generative neural network model and obtaining inference output data comprising generated text organized according to the output structure; and
transmitting, via the packet-switched network, display data derived from the inference output data and the edited data to the terminal device for rendering on a display of the terminal device.
